(19) United States
(12) Patent Application Publication
(10) Pub. No.: US 2014/0287317 A1
(43) Pub. Date: Sep. 25, 2014

(54) METHOD FOR PREPARING A SILICON/CARBON COMPOSITE MATERIAL, MATERIAL SO PREPARED, AND ELECTRODE, IN PARTICULAR NEGATIVE ELECTRODE, COMPRISING SAID MATERIAL

(71) Applicant: COMMISSARIAT A L'ENERGIE ATOMIQUE ET AUX ENERGIES ALTERNATIVES, Paris (FR)

(72) Inventors: Pascal Tiquet, Grenoble (FR); Mélanie Alias, Poligny (FR)

(73) Assignee: COMMISSARIAT A L'ENERGIE ATOMIQUE ET AUX ENERGIES ALTERNATIVES, Paris (FR)

(21) Appl. No.: 14/353,398

(22) PCT Filed: Oct. 25, 2012
(86) PCT No.: PCT/EP12/71177

§ 371 Date: Apr. 22, 2014

(30) Foreign Application Priority Data
Oct. 25, 2011 (FR) 1159685

(51) Int. Cl. H01M 4/36; H01M 4/583; H01M 10/0525; H01M 4/38

(52) U.S. Cl. CPC H01M 4/366; H01M 4/364; H01M 4/386; H01M 4/583; H01M 10/0525
USPC 429/231.8; 427/113

(57) ABSTRACT

Silicon/carbon composite material, consisting of at least one capsule comprising a silicon shell within which there are carbon nano-objects partially or totally covered with silicon, and silicon nano-objects. The capsule may further comprise an amorphous carbon shell inside the silicon shell and adjacent to the latter. A method for preparing said composite material is disclosed.

### TECHNICAL FIELD

The invention relates to a silicon/carbon composite material.

More specifically, the invention is concerned with a silicon/carbon material consisting of capsules.

The invention also concerns a method for preparing said silicon/carbon composite material.

In particular the invention is concerned with a silicon/carbon composite material intended for use as an electrochemically active electrode material, in particular a negative electrode material, in non-aqueous organic electrolyte electrochemical systems, such as organic electrolyte rechargeable electrochemical batteries, in particular in lithium batteries yet more specifically in lithium ion batteries.

The invention is also concerned with an electrode, in particular a negative electrode, which comprises this composite material as an electrochemically active material.

The technical field of the invention can be defined in general terms as that of silicon/carbon composite materials.

### THE STATE OF THE PRIOR ART

The growth in the portable equipment market has allowed lithium battery technology to emerge, and the purchasing specifications for equipment using these batteries has become increasingly demanding. This equipment requires ever more power and ever longer operating life, whilst at the same there is a desire to reduce the size and weight of the batteries.

Lithium technology offers the best characteristics relative to other existing technologies. The element lithium is the lightest and most strongly reducing of the metals and electrochemical systems which use lithium technology can achieve voltages of 4V as against 1.5V for other systems.

Lithium ion batteries offer an energy density per unit mass of 200 Wh/kg as against 100 Wh/kg for NiMH technology, 30 Wh/kg for lead and 50 Wh/kg for NiCd.

However, current materials and in particular active electrode materials, are reaching their limits in terms of performance.

These active electrode materials consist of an electrochemically active material which constitutes a receiving structure wherein cations, for example lithium cations are inserted, and are deinserted during cycling. The most widely used negative electrode active material in lithium ion batteries is graphite carbon, but its reversible capacity is low and it exhibits an irreversible capacity loss, or “ICL”.

In the case of negative electrode active materials in Lithium/ion systems, one possibility for improving performance is to replace the graphite by another material with better capacity, such as tin or silicon.

With an estimated theoretical capacity of 3579 mAh/g (for Si→Li_{3,75}Si), silicon represents a desirable alternative to carbon as a negative electrode material. Nevertheless, this material has a major drawback which prevents its use. In effect, the expansion in volume, which can reach 400%, that silicon particles undergo when being charged and upon insertion of lithium (LI-ion system) results in deterioration of the material, with the particles cracking and peeling away from the current collector.

This embrittlement of the material is at present very difficult to control and leads to poor cyclability of the electrode.

It has been shown that the use of these materials, such as silicon, in the form of nanometric powders can limit the extent of these deterioration effects and lead to improved reversibility for capacities close to theoretical values.

The use of nanometric silicon powders is, however, soon faced with problems of maintenance of electron percolation within the electrode.

In order to provide a material which is capable of maintaining the integrity of the electrode after repeated charge-discharge cycles and in order to overcome the problems inherent to silicon, for several years much research has dealt with materials wherein the alternative material, such as silicon, is coupled with carbon. In particular this involves silicon/carbon composite materials wherein silicon is generally dispersed in a carbon matrix.

The objective of these materials is to combine the good cyclability of carbon with added capacity due to the addition of silicon.

In the literature, various methods such as energetic grinding and chemical vapour deposition (CVD) are envisaged for preparing a silicon/carbon composite.

Energetic crushing involves using the mechanical action of balls to mix particles of silicon and of carbon.

In the case of chemical vapour deposition (CVD), silane (Si H₄) is generally the precursor gas used. The carbon to be coated is located within the furnace enclosure. When the gas passes through the heated enclosure it decomposes into particles of nanometric silicon on the surface of the carbon.

The process for CVD deposition on graphite is used to synthesise composites with effective improvements in the specific capacity of the graphite of more than 30%, as described in the document by M. M. Holzapfel, H. Buqa, F. Krumeich, P. Novak, F. M. Petrat and C. Veit., Electrochemical and Solid-State Letters, 8: A 516, 2005.

Furthermore the preferential nucleation of silicon on flat silicon, for example in the form of “wafers” and on carbon in the form of carbon nanotubes (“CNT”), of carbon fibres of on flat carbon has also been described.

Thus the document by Li-Feng Cui, Yuan Yang, Ching-Mei Hsu and Yi Cui, Nano Lett., 2009, 9 (9), pp 3370-3374 describes a composite with carbon and silicon nanofibres.

A CVD chemical vapour deposition method specifically suited to the preparation of carbon/silicon composite materials is the fluidised bed CVD deposition method.

The fluidisation of nanometric powders is, however, very difficult due to the predominance of Van-der-Waals interactions.

These interactions can be cohesive and flow of gas is then not sufficient to break the interaction between the particles on a nanometric scale, or, on the contrary, highly volatile such as carbon nanotubes and silicon nanopowders.

As is explained in the article by J. R. Rodriguez Ruvalcaba, B. Caussat, H. Âmati and J. P. Couderc, “Extension du procédéde dépôt de silicium par CVD en lit Fluidisé à des conditions opératoires peu conventionnelles: dépôts sur poudres poreuses et/ou sous pression réduite”, Chemical Engineering Journal 73 (1999), pp 61-66; there has been very little work on fluidisation of nanometric powders under vacuum.

The document by C. Vahlas, B. G. Caussat, P. Serp, “Principles and applications of CVD powder technology”, Materials Science and Engineering R53, Pages 1-72, (2006), describes the principles and application of CVD in powder technologies.

This document summarises the various fluidised bed technologies and establishes a classification known as the Geldart classification of powders according to their behaviour in fluidised beds.

The authors conclude that the fluidised bed technique is suitable for class A powders (particle size distribution of from 20 μm to 150 μm and of density less than 2 g/cm³), and B (particle size distribution of from 40 μm to 500 μm and of density between 2 g/cm³ and 4 g/cm³).

Class C powders such as nanoparticles are therefore considered to be incompatible with the fluidised bed technique.

Carbon nanotube powders and silicon nanoparticle powders fall into class C of the Geldart classification as is indicated in the document by Jun Liu and Andrew T. Harris, “Industrially scalable process to separate catalyst substrate materials from MWNTs synthesised by fluidised-bed CVD on iron/alumina catalysts”, Chemical Engineering Science 64 (2009), pages 1511-1521.

Thus, document FR-A-2 928 938 describes a method and a system for deposition of a metal or a metalloid on carbon nanotubes (CNT).

CNTs are blended with a precursor of a metal or of a metalloid such as silicon for a period which is sufficient for the CNTs to become impregnated with this precursor, then the impregnated CNTs are introduced into a reactor by a stream of gas, so as to obtain a fluidised bed of CNTs in the heated reactor.

The heat causes a deposit of metal or metalloid such as silicon to be formed on the CNT powder.

It seems that the method in this document can be used to deposit not silicon, but actually SiC.

The method in this document cannot be used to create a deposit of pure silicon on the carbon nanotubes.

Furthermore the deposit is not homogeneous due to the existence of agglomerates of carbon nanotubes.

Yields are often low and the volatility of the nanotubes used is such that they are rapidly dispersed in the reactor, leading to fouling of the latter by the nanotubes.

The document by Yoshihide Mawatari, Tetsu Koide, Tomoaki Ikegami, Yuji Tatemoto and Katsuji Noda, “Characteristics of vibro-Fluidization for fine powder under reduced pressure”, Advanced Powder Technol., Vol. 14, No. 5, pages 559-570 (2003) describes how to combine a fluidised bed with mechanical vibration technology in order to break the Van-Der-Waals bonds.

This document describes in particular vibration conditions for maintaining the fluidised bed under low pressure for powders composed of micrometric glass particles with a dimension of 6 μm.

The cohesion of nanometric powders is however an order of magnitude greater than that of micrometric fine powders.

Another phenomenon rarely dealt with in the literature is the low apparent (bulk) density of nanopowders, which, for CNT and silicon powders, is less than 0.2 g/cm³.

In order to use fluidised beds of such nanopowders which exhibit such low apparent densities in a chemical vapour deposition method, very large, industrially unprofitable reactors would have to be designed.

Furthermore, Si/C composites have better cyclability than pure silicon, but exhibit a drop in capacity after a number of charge-discharge cycles. This can be explained by the microstructural change of silicon during cycling, since the particles of silicon swell until they burst out and peel away from the electrode. There is insufficiently close contact between the carbon and silicon for the carbon to compensate for the changes in volume of the silicon.

In the light of the above, therefore, there exists a need for a Silicon Carbon Si/C composite which, when it is used as an electrode active material, in particular a negative electrode, for example an electrode for a lithium ion battery and in particular a negative electrode material for a lithium ion battery, exhibits excellent mechanical strength during cycling as well as excellent levels of electrochemical performance in terms of capacity, stability of capacity and of yield.

There exists in particular a need for a composite silicon/carbon material comprising carbon nanotubes which offer a large specific surface area as well as carbon nanoparticles which similarly possess a large specific surface area which in particular ensures a high specific capacity wherein a deposit of pure silicon is effectively made on the carbon nanotubes.

There subsequently exists a need for such a material wherein the nanoparticles and nanotubes are securely confined in order to prevent them leaking out and to prevent their dissemination in the environment.

There exists a need in addition for a method for the preparation of such a material using a chemical vapour deposition method in a fluidised bed.

There subsequently exists a need for such a method that is simple, reliable and of low cost.

The goal of the present invention is to provide a silicon carbon composite material and a method for the preparation of this silicon carbon composite material which, amongst other things, meets the needs stated above.

The goal of the present invention is further to provide a silicon carbon composite material and a method of preparation of a silicon/carbon composite material which does not offer the drawbacks, faults, limitations and disadvantages of the materials and methods of the prior art and which solve the problems of the materials and methods of the prior art.

### SUMMARY OF THE INVENTION

The invention relates to a composite silicon/carbon material, consisting of at least one capsule comprising a silicon shell within which there are carbon nano-objects partially or totally covered with silicon, and silicon nano-objects.

Advantageously, the capsule may further comprise an amorphous carbon shell inside the silicon shell and adjacent to the latter.

This amorphous carbon shell can be regarded as forming a “sub-shell” made of amorphous carbon.

In the case where the capsule further comprises such a sub-shell, the silicon shell may totally or partially cover the amorphous carbon sub-shell.

In other terms, in this case the silicon shell may be continuous or discontinuous and therefore totally or partially cover the amorphous carbon sub-shell which is continuous.

In the general case the silicon shell is continuous.

The carbon nano-objects may be selected from nanotubes, nanowires, nanofibres, nanoparticles, carbon nanocrystals, carbon blacks, and mixtures thereof; and the silicon nano-objects may be selected from nanotubes, nanowires, nanofibres, nanoparticles, nanocrystals of silicon, and mixtures thereof.

Advantageously the carbon nano-objects are selected from carbon nanotubes and carbon nanofibres; and the silicon nano-objects are selected from silicon nano-particles.

Advantageously the porosity of the interior of the capsule is greater than 50%.

Advantageously the silicon shell is a dense shell with a density of from 1 to 3 g/cm³, preferably of from 1 to 2 g/cm³ measured using helium pycnometry.

When an amorphous carbon sub-shell is present, the density of the shell and of the sub-shell is generally 1 to 3 g/cm³, preferably 1.8 to 2.5 g/cm³, more preferably 1.9 g/cm³ to 2.3 g/cm³, measured using helium pycnometry.

The apparent (bulk) density of the capsules is generally from 0.1 g/cm³ to 0.2 g/cm³, for example 0.112 g/cm³.

The BET surface area of the capsules may generally be between 20 and 70 m²/g depending on the manufactured batches.

Advantageously the capsule is in the form of a hollow, sphere or quasi (near) sphere.

Advantageously the capsule generally has a larger dimension, such has a diameter, of from 0.5 mm to 2.5 mm, preferably of from 0.5 mm to 2 mm, even more preferably of from 1 mm to 2 mm, and better still, of from 1.5 mm to 2 mm.

In the case where a carbon sub-shell is present, the capsules preferably have a larger dimension, such as a diameter of from 0.5 to 2.5 mm, preferably of from 1.5 mm to 2.5 mm, for example of 2 mm.

Advantageously the carbon nano-objects such as the carbon nanotubes or carbon nanofibres form both a three-dimensional network which trap the silicon nano-objects such as the silicon nano-particles, and a three dimensional skeleton, partially or totally sheathed in silicon.

Advantageously the silicon shell may have a thickness of from 50 nm to 500 nm, preferably of from 100 to 500 nm, and yet more preferably of from 100 nm to 200 nm.

Advantageously the silicon shell and the amorphous carbon sub-shell have a total thickness of from 50 nm to 500 nm, preferably of from 100 to 500 nm, and yet more preferably of from 100 nm to 200 nm.

Advantageously the silicon of the shell and the silicon which completely or partially covers the carbon nano-objects, such as carbon nanotubes, consists in majority and preferably totally, of amorphous silicon or of partially or totally recrystallised cubic silicon.

Advantageously the capsule comprises a silicon shell inside which are:
a network of carbon nano-objects, such as carbon nanotubes or nanofibres, partially or totally covered with amorphous silicon;
agglomerates (clusters) of cubic silicon nano-objects such as cubic silicon nanoparticles which trap one or more carbon nano-object(s), such as carbon nanotubes or nanofibres;
amorphous silicon seeds on the surfaces of the agglomerates;
amorphous silicon nanowires on the amorphous silicon seeds.

Agglomerates of cubic silicon nano-objects, for example of nanoparticles of cubic silicon, are formed by nano-objects, for example by cubic silicon nanoparticles which have acted as precursors for the partial chemical reaction Si+SiO₂→2SiO and which have then collapsed.

The liquid or gaseous precursor which is thermally decomposed under vacuum provides, on the surfaces of these same agglomerates, seeds of amorphous silicon for the growth of silicon nanowires not supported by carbon nano-objects, such as CNTs.

Advantageously the amorphous silicon nanowires have a length of 0.5 μm to 10 μm and a diameter of between 5 nm and 50 nm.

The carbon nano-objects such as carbon nanotubes which are partially or totally covered with amorphous silicon and the silicon nanowires may be partially or totally crystallised and twinned, in particular in the direction of the cross section of the silicon nanowires and of the carbon nano-objects such as the carbon nanotubes, depending on the duration of the heat treatment after the liquid or gaseous precursor injection phase.

The material according to the invention has never been described or suggested in the prior art.

In particular in the material according to the invention, the carbon nano-objects, such as carbon nanotubes, are effectively coated with silicon, generally in a homogeneous manner, or not, depending on the applications of the batteries.

The material according to the invention does not exhibit the faults, limitations and disadvantages of silicon/carbon composite materials of the prior art.

The material according to the invention possesses excellent mechanical properties and does not undergo deterioration during cycling.

The composite material according to the invention possesses a high specific capacity which is at least equal to 800 mAh/g.

This specific capacity is greater than those of silicon/carbon composite materials of the prior art as the comparative tests in example 5 and the graph of FIG. 13 show.

The material according to the invention, whilst possessing a capacity which is greater than those of silicon carbon composites of the prior art does not exhibit their drawbacks, in particular as regards unsatisfactory mechanical properties.

Importantly, in the materials according to the invention, the silicon shell, which is generally dense, with a density of close to, for example, 1 to 2 g/cm³ and which is continuous, contributes to maintaining the mechanical strength of the capsules, and in addition ensures effective confinement during the synthesis of the nanostructure.

The nano-objects such as the nano-tubes or nano-particles, both of carbon and of silicon, are found inside said shell.

Each capsule behaves like as mini-reactor which is semi-open to gases and precursors.

The silicon shell thus ensures that the material according to the invention is secure, since the silicon nano-objects and carbon nano-objects such as carbon nanotubes remain confined inside this shell.

This shell therefore plays a “nano-security” role in the sense that it prevents nano-objects from escaping and being disseminated into the environment.

The invention also concerns a method for preparing said silicon/carbon composite material described above, wherein:
Freeze-dried capsules prepared by the freeze-drying of first capsules are placed inside a thermal chemical vapour deposition reactor under vacuum, said first capsules each comprising a solvent, carbon nano-objects and silicon nano-objects coated with macromolecules of a polysaccharide being distributed homogeneously in each of the first capsules, and said macromolecules forming, in at least part of each of the first capsules, a gel by cross-linking with positive ions;
a carrier gas is introduced into the reactor to form a fluidised bed of the freeze-dried capsules;
a silicon-containing silicon precursor compound is injected into the reactor, wherein a temperature and a pressure have been previously established such that silicon is deposited by evaporation and condensation on the carbon nano-objects such as carbon nanotubes inside the capsules, so that the reaction Si+SiO₂→2 SiO is initiated, and that evaporation and sorption of the SiO takes place at the surface of the silicon nano-objects and of the carbon nano-objects;
the injection of the silicon-containing silicon precursor compound is stopped and a deoxygenation treatment of the capsules is carried out;
the reactor is cooled, preferably to ambient temperature, and the capsules are extracted from the reactor.

Said freeze-dried capsules are prepared by the method described in application WO-A1-2010/012813, wherein reference should be made to the description.

Advantageously, in the freeze-dried capsules, the silicon nano-objects, for example the silicon nanoparticles, are distributed in a homogeneous manner inside a three-dimensional network of carbon nano-objects, preferably of carbon nanotubes or nanofibres.

This condition is necessary so that the coating of the carbon nano-objects, for example of the CNTs, by the silicon is as homogeneous as possible.

Advantageously the freeze-dried capsules have a size defined by their largest dimension, such as their diameter, of from 2 mm to 3.5 mm, for example of from 2 mm to 3 mm.

Advantageously, the freeze-dried capsules are composed, as mass percentage of from 50% to 70%, for example 60%, of polysaccharide macromolecules, of from 20% to 40%, for example 35% of silicon, and of from 1% to 20%, for example 5% of carbon nano-objects, for example carbon nano-tubes.

Advantageously the polysaccharide is chosen from pectins, alginates, alginic acid, carrageenans and mixtures thereof.

Advantageously the silicon-containing precursor compound is selected from silane, trichlorosilane and tetra-alkyl (1 to 4C) silanes such as tetramethylsilane.

Advantageously the carrier gas is selected from hydrogen, argon and mixtures thereof.

Advantageously a temperature of 900° C. to 1200° C. and a pressure of 1 to 50 mbar are established in the reactor.

As stated above, at the end of the silicon deposition, a deoxygenation treatment of the capsules is carried out, in particular a deoxygenation treatment of the carbon nano-objects, for example of the carbon nanotubes.

Advantageously this deoxygenation treatment (oxygen removal) is carried out at a temperature of 1000° C. to 1450° C., for example of 1350° C., for a duration of from 5 minutes to 60 minutes, for example of 10 minutes, in an atmosphere of pure hydrogen, or in an atmosphere of inert gas, or in an atmosphere of a mixture of hydrogen and of an inert gas such as hydrogen-containing argon.

The method according to the invention has never been described in the prior art.

The method according to the invention differs fundamentally from the methods of the prior art in that it uses specific freeze-dried capsules to form the fluidised bed of the CVD reactor.

The use of these freeze-dried capsules in a CVD process with a fluidised bed has never been described or suggested in the prior art.

The method according to the invention allows a composite material to be prepared for the first time which comprises carbon nano-objects, such as carbon nanotubes, effectively covered with pure silicon, and silicon nano-objects, for example silicon nanoparticles, by a chemical vapour deposition method with a fluidised bed.

The method according to the invention will therefore go against a widespread prejudice according to which it was impossible to prepare a composite material comprising nano-objects of different materials, for example silicon nanoparticles and carbon nanotubes, by a CVD deposition method in a fluidised bed.

The method according to the invention, in particular because it uses said freeze-dried capsules solves the problems of the methods of the prior art for the preparation of silicon/carbon composite materials and in particular methods for the preparation of silicon/carbon composite materials comprising silicon and carbon nano-objects in particular carbon nanotubes and silicon nanoparticles.

The yields of the method according to the invention are high, and the use of freeze-dried capsules avoids all the problems that were associated with the volatility of nano-objects, in particular nanotubes, and with the dispersion of nano-objects, in particular of nanotubes, in the reactor.

In the method according to the invention, no fouling of the reactor by nano-objects, and in particular by nanotubes, occurs.

In other words, the method according to the invention makes it possible to use, in a fluidised bed, both silicon nano-objects and carbon nano-objects, for example silicon nanoparticles and a carbon nanometric powder (CNTs, carbon black, carbon fibres etc.)

This simultaneous use in a fluidised bed of both silicon nano-objects and carbon nano-objects is specifically made possible according to the invention by the prior manufacture of porous capsules which contain these both types of nano-objects, for example these both types of powders, with control over their distribution in these capsules.

The manufacture of these capsules is carried out by the method described in application WO-A1-2010/012813.

The mixing, under vacuum, of two powders of densities as different as carbon powder and silicon powder, the ratio of whose densities may be for example equal to 2, is not technically foreseeable in a fluidised bed CVD enclosure.

According to invention, such a mixture can, surprisingly, be made by transforming these powders beforehand into pre-organised capsules as described in application WO-A1-2010/012813.

In the literature, there are very few studies prior to 1999 which involve fluidisation under vacuum.

After 1999, the great majority of studies relate to catalyst supports such as activated carbon and porous alumina, but not pre-organised nanostructure capsules such as those used in application WO-A1-2010/012813.

The method described in application WO-A1-2010/012813 effectively allows the class to be changed by changing from class C to class A of the classification according to Geldart.

The method according to the invention also provides a solution to the problems raised above associated with the low apparent (bulk) density of the powders.

The method according to the invention in effect provides control over the apparent (bulk) density of the mixtures of silicon powders and of carbon nanoparticles such as CNTs.

In effect, the method according to the invention uses capsules prepared by the method of application WO-A1-2010/012813 which maximises the amount of CNTs coated with silicon within sub-millimetre sized objects.

The invention furthermore concerns an electrode comprising as an electrochemically active material the composite material described above.

This electrode inherently possesses all the advantageous properties associated with the composite material that it contains as an electrochemically active material.

This electrode may be a positive electrode or a negative electrode.

The invention relates in addition to an electrochemical system comprising an electrode such as described above.

Advantageously, this electrochemical system may be a non-aqueous electrolyte system such as a rechargeable electrochemical battery with a non-aqueous electrolyte.

This electrochemical system may in particular be a lithium ion battery.

Other characteristics and advantages of the invention will emerge more clearly on reading the detailed description, which is given for illustrative purposes only and is in no way restrictive, with reference to the appended drawings.

### BRIEF DESCRIPTION OF THE DRAWINGS

FIG. 1 is a photograph taken using a microscope, which shows the organisation of carbon nanotubes as a three-dimensional network and silicon nanoparticles, after extrusion of an extrudable polycarbonate paste.

This extrudable paste is prepared from a mixture produced from the dispersion of carbon nanotubes and silicon nanoparticles in a first solvent, then dissolution of the polysaccharides in this mixture, before freezing and freeze-drying of the capsules.

In order to be able to observe the organisation, the polycarbonate was then dissolved in acetone to reveal the organisation of the CNTs and of the silicon nanoparticles.

The scale shown in FIG. 1 represents 2 μm.

FIGS. 2 and 3 are photographs taken using a microscope which show the internal organisation of freeze dried capsules, consisting of carbon nanotubes and of silicon nanoparticles obtained by the method of document WO-A1-2010/012813 before the CVD processing.

The scale shown in FIG. 2 represents 3 μm.

The scale shown in FIG. 3 represents 1 μm.

FIG. 4 is a photograph which shows a set of capsules which constitute the material of the invention, in a jar.

This material consists of silicon, of carbon nanotubes and of alginate in the proportions 57% alginate, 33% silicon and 10% of CNTs.

FIG. 5A is a photograph taken using a microscope, which shows the amorphous silicon deposit obtained at 900° C. by the method according to the invention on freeze-dried capsules obtained by the method of application WO-A1-2010/012813. The proportions are 80% silicon and 20% of CNT.

The scale shown in FIG. 5A represents 300 nm.

FIG. 5B is a photograph taken using a microscope which shows the coating of amorphous silicon around a network of carbon nanotubes generated on the one hand by the surface reactions of the cubic silicon nanoparticles (Si+SiO₂→SiO) and on the other hand by the decomposition of the silane precursor generating the nucleation-growth phenomena of amorphous silicon on the “collapsed” cubic silicon nanoparticles around the network of carbon nanotubes and on the carbon nanotubes alone.

The scale shown in FIG. 5B represents 200 nm.

FIG. 6 is a graph which shows an X-ray diffraction pattern (XRD) on the macroscopic scale which shows the presence in majority of cubic silicon in the capsules prepared by the method according to the invention.

The abscissa shows 2 Theta and the ordinate shows the number of counts/sec;

FIG. 7 is a graph showing an energy dispersion spectroscopy spectrum (“EDS”) on a set of carbon nanotubes coated with silicon which show the presence in majority of cubic silicon at the nanostructure scale;

FIG. 8 is a schematic vertical cross-sectional view of a battery in the form of a button battery comprising, for example a negative electrode to be tested according to the invention.

FIG. 9 is a schematic lateral cross-sectional view of the ultrasound device used to disperse the silicon nanoparticles and the carbon nanotubes;

FIG. 10 is a schematic lateral cross-sectional view of the device for preparing capsules of freeze dried self-assembled silicon nanoparticles and carbon nanotubes;

FIG. 11 is a schematic lateral cross-sectional view of the extrusion device used for the manufacture of the electrode material according to the invention;

FIG. 12 is a graph which gives the specific capacity (in mAh/g), under discharge (white empty round markers) and under charge (black filled-in round markers), as a function of the number of cycles during the test according to C/20 cycling of a button battery such as represented in FIG. 8 (example 4), whose positive electrode consists of, is composed of lithium metal and whose negative electrode comprises as an active negative electrode material a composite material prepared in the example 1 by the method according to the invention;

FIG. 13 is a graph which gives the specific capacity (in mAh/g) under discharge as a function of the number of cycles (squared markers) during a test according to C/20 cycling of a button battery such as represented in FIG. 8, whose positive electrode is composed of lithium metal and whose negative electrode comprises as an active negative electrode material a composite material according to the invention; as well as the specific capacity (in mAh/g) under discharge as a function of the number of cycles during the test according to C/20 cycling of a button battery such as represented in FIG. 8 whose positive electrode is made up of lithium metal and whose negative electrode comprises as an active negative electrode material a material which does not conform to the invention (lozenge shaped markers) (see example 5).

FIG. 14A is a photograph of a preparation of 4 composite capsules according to the invention, before observation using an electron microscope.

The scale shown in FIG. 14A represents 2 mm.

FIG. 14B is an x-ray tomography snapshot of a composite capsule according to the invention showing the near-spherical shape of this capsule.

FIG. 15 is a photograph taken using a microscope which shows an example of damage to the protective shell of the composite capsules during synthesis.

The scale shown in FIG. 15 represents 100 μm.

FIG. 16A is a photograph taken using a microscope of a composite capsule according to the invention after the detachment of a shell fragment.

The scale shown in FIG. 16A represents 1 μm.

FIG. 16B is a photograph taken using a microscope of a composite capsule with a zone which is rich in silicon particles and of a zone which is rich in carbon nanotubes covered with amorphous silicon.

The scale shown in FIG. 16A represents 1 μm.

FIGS. 17A and 17B are photographs taken using a microscope, of the first type of silicon nano-objects.

The scale shown in FIG. 17A represents 2 μm and the scale shown in FIG. 17B represents 300 nm.

FIG. 18 is a photograph taken using a microscope of the second type of silicon nano-objects.

The scale shown in FIG. 18 represents 200 nm.

FIGS. 19A and 19B are photographs taken with a microscope which show examples of carbon nano-objects near to a carbon nanotube agglomerate.

The scale shown in FIG. 19A represents 200 nm.

The scale shown in FIG. 19B represents 100 nm.

FIG. 20 is an X-ray tomography snapshot which shows the interior of composite capsules.

FIGS. 21A and 21B are photographs taken using a microscope which show the structure of the internal walls of the composite capsules.

The scale shown in FIG. 21A represents 400 nm.

The scale shown in FIG. 21B represents 1 μm.

FIG. 22A is a photograph which shows the freeze-dried capsules before synthesis.

The scale shown in FIG. 22A represents 2 mm.

FIG. 22B is an X-ray tomography snapshot showing freeze-dried capsules before synthesis.

The scale shown in FIG. 22B represents 0.5 mm.

FIGS. 23A and 23B are photographs taken using a microscope which show the external structure of a freeze-dried composite capsule with cracks.

The scale shown in FIG. 23A represents 200 μm.

The scale shown in FIG. 22B represents 100 μm.

FIGS. 24A and 24B are photographs taken using a microscope, which show the organisation of the carbon nanotubes and of the silicon particles inside the cells of the freeze-dried capsules.

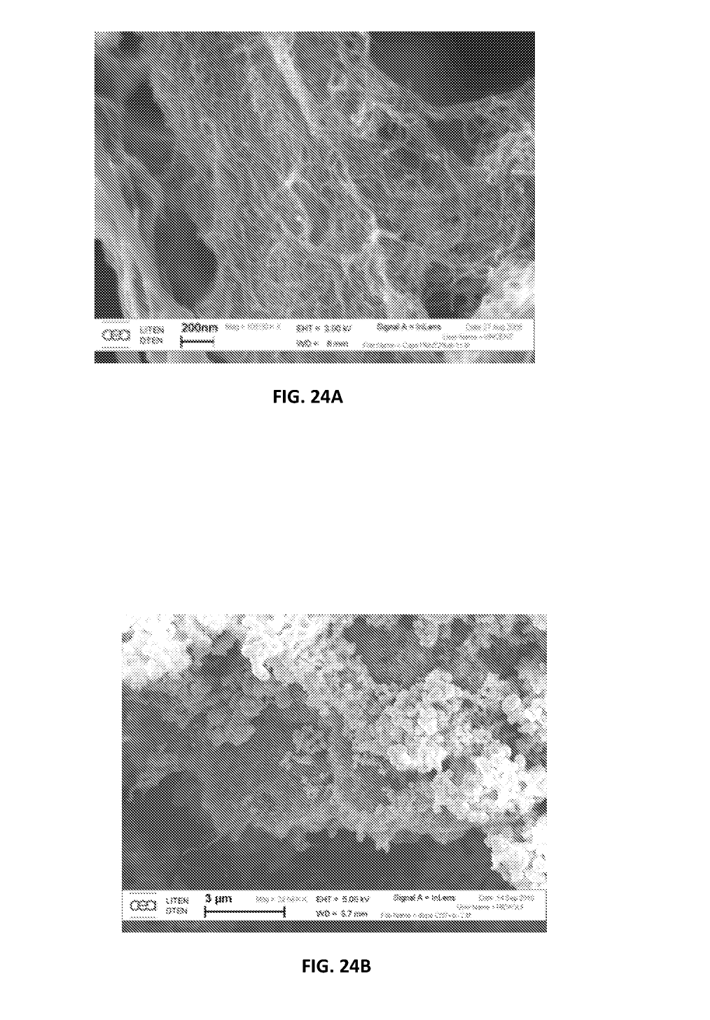

The scale shown in FIG. 24A represents 200 nm.

The scale shown in FIG. 24B represents 3 μm.

### DETAILED DESCRIPTION OF SPECIFIC EMBODIMENTS

The detailed description which follows is for the most part made in relation to the method according to the invention for preparation of a carbon-silicon composite material consisting of silicon shell capsules, but is also contains information which applies to the materials according to the invention themselves.

As a preamble to this detailed description, we will first of all define certain terms used in the present document.

By the term nano-objects in general it is meant any object alone or linked to a nanostructure of which at least one dimension is less than or equal to 500 nm, preferably less than or equal to 300 nm, yet more preferably less than or equal to 200 nm and better less than or equal to 100 nm, for example is in the range of from 1 to 500 nm, preferably of from 1 to 300 nm, even more preferably of from 1 to 200 nm, better still of from 1 to 100 nm, and better still of from 2 to 100 nm, or even of from 5 to 100 nm.

These nano-objects may be, for example, nanoparticles, nanowires, nanofibres, nanocrystals or nanotubes, for example carbon nanotubes (“CNT”) with single walls (“SWNT” or Single Wall Nanotube).

By the term nanostructure in general it is meant an architecture made up of an assembly of nano-objects which are organised with a functional logic and which are structured in a space ranging from the cubic nanometer to the cubic micrometer.

By the term polysaccharide in general it is meant a polymeric organic macromolecule made up of a chain of monosaccharide units. Such a macromolecule may be represented by a chemical formula of the form —[C_{X}(H₂O)_{y}]ₙ—.

As is specified later, use is preferably made, according to the invention, of macromolecules made up of mannuronic acid (group M) and guluronic acid (group G).

The macromolecular chains best suited for the invention are those with a maximum of M groups (that is where the M group/G group ratio is greater than 60%), since through coordination they retain a greater number of ions causing gelification of the capsule.

This description generally refers more specifically to an embodiment wherein the composite material prepared using the method according to the invention is the active positive or negative electrode material of a rechargeable lithium ion battery, but is it of course evident that the description which follows may be easily extended and adapted as required to any application and any mode of application of the composite material prepared by the process according to the invention.

In a first step in the process according to the invention, freeze dried capsules prepared by the freeze-drying of first capsules are placed inside a thermal chemical vapour deposition reactor under vacuum, where said first capsule comprises a solvent, carbon nano-objects such as carbon nanotubes, and silicon nano-objects such as silicon nanoparticles, said nano-objects being coated with macromolecules of a polysaccharide and distributed homogeneously within said first capsule, and where said macromolecules form, in at least part of the first capsule, a gel by cross-linking with positive ions.

The first capsule (or first agglomerate) may be called, for simplification “gelled capsule” or “gelled agglomerate”.

The capsule (or agglomerate) prepared by freeze drying of this first gelled capsule (or first agglomerate) may be called, for simplification, “freeze-dried gelled capsule (or agglomerate)” or “freeze-dried capsule (or agglomerate)”.

By the term “distributed in a homogeneous manner” it is generally meant that the nano-objects are distributed uniformly, regularly throughout the entire volume of the first capsule and that their concentration is substantially the same throughout the volume of the first capsule (of the first agglomerate), in all parts of the latter.

This homogeneous distribution is furthermore preserved in the freeze-dried capsule (agglomerate) prepared from this first capsule.

The term “freeze-dried” is a term well-known to those skilled in the art. Freeze-drying generally comprises a freezing step during which the solvent (liquid) of the first agglomerate is given a solid form, for example in the form of ice, then a sublimation step during which, under the effect of the vacuum, the solid solvent such as ice is transformed directly into vapour, for example water vapour, which is recovered. If appropriate, once all the liquid solvent, for example all the ice, is eliminated, the capsules, agglomerates are cold dried.

The “gelled” freeze-dried capsules are prepared by the method described in application WO-A1-2010/012813 wherein the description may be referred to.

Said “first” capsules and said gelled freeze-dried capsules prepared by the method described in application WO-A1-2010/012813 must not be confused with the silicon shell capsules which constitute the composite material according to the invention.

In effect, by the term “capsule” (or agglomerate) in application WO-A1-2010/012813 and by the terms first capsules and gelled freeze-dried capsules, it is generally meant a system comprising, preferably consisting of, composed of, a solvent, preferably a solvent comprising in majority water or consisting of water; nano-objects or nano-structures, namely, in the present instance carbon nano-objects such as carbon nanotubes, and silicon nano-objects such as silicon nanoparticles; polysaccharide macromolecules; and positive ions which act as nodes for cross-linking between two polysaccharide molecules.

The method described in application WO-A1-2010/012813 may if necessary be adapted and optimised in particular in order to adjust the size and diameter of the first capsules (the capsules before freeze drying) as well as the ratios of carbon nano-objects for example carbon nanotubes “CNT”/Si nano-objects, for example Si nanoparticles, and the degree of porosity.

Thus, it is generally arranged for these first capsules to preferably be “small” capsules with a diameter generally of from 100 μm to 5 mm, for example of from 2 to 3 mm or of from 4 to 5 mm in order to achieve optimum performance in the fluidised bed and maximum amount of mass in the volume of the “CVD” chemical vapour deposition reactor.

The protocol for preparation of the first capsules described in this application WO-A1-2010/012813 will also be advantageously optimised so that the silicon nano-objects, preferably silicon nanoparticles, are preferably distributed in an homogeneous manner in a three-dimensional network of carbon nano-objects, for example of carbon nanofibres or carbon nanotubes (“CNT”).

Furthermore the method of application WO-A1-2010/012813 is implemented in accordance with the invention with specific nano-objects or nanostructures which are carbon nano-objects, and silicon nano-objects.

Preferably, the method of application WO-A1-2010/012813 is implemented in accordance with the invention with nano-objects consisting of carbon nanotubes or nanofibres and silicon nanoparticles.

The carbon nanotubes (“CNT”) may be single-wall carbon nanotubes (“SWCNT”) or multi-wall carbon nanotubes (“MWCNT”) such as double wall carbon nanotubes (“DWCNT”).

The carbon nanotubes may have an average length of from 1 μm to 10 μm, for example of 2 μm and a mean diameter of from 10 nm to 50 nm, for example of 20 nm.

Examples of carbon nanotubes that can be used according to the invention are carbon nanotubes of the brand Graphistrength® and are described later.

The silicon nanoparticles may have an average size defined by their largest dimension, such as their diameter, of from 100 to 500 nm.

For example, silicon nanoparticles may take the form of a powder whose particle size distribution is centred on 200 nm or 310 nm.

An example of a silicon powder which may be used according to the invention is available from the S'tile company and is described below.

In a first step of the method of application WO-A1-2010/012813, in a first solvent generally comprising in majority water, nano-objects or nanostructures are dispersed, namely in the present instance carbon nano-objects such as carbon nanotubes and silicon nano-objects such as silicon nanoparticles, and in the first solvent is dissolved at least one macromolecule belonging to the polysaccharides family, by means of which a first solution is obtained wherein the nano-objects or nano-structures are dispersed.

At this stage of the method, a polymer or monomer soluble in the first solvent can be added to the first solution, for example a water soluble monomer, whose function will be to maintain the gelled structure and to mechanically reinforce the latter after the first solvent such as water has left. It is thus possible to minimise the reduction in volume at the time when freeze-drying takes place.

By the term solvent which comprises in majority water, it is meant in general that the solvent contains 50% by volume of water or more, preferably 70% by volume of water or more, and even more preferably more than 99% by volume of water, for example 100%.

The first solvent may include apart from the water in the proportions stated above, at least one other solvent compound, generally selected from alcohols, in particular aliphatic alcohols such as ethanol; polar solvents, in particular ketones such as acetone, and mixtures thereof.

Apart from the above-mentioned solvents, the first solution may, as has been stated above, contain in addition at least one polymer selected from all the polymers that are soluble in the first solvent, in particular water-soluble polymers such as PEGs, poly(ethylene oxides), polyacrylamides, poly (vinyl pyridine), (meth)acrylic polymers, celluloses, chitosans, PVAs, whose function is to provide effective stability of the dispersion of nano-objects or nano-structures, namely in the present case, carbon nanostructures and silicon nanoparticles.

There are no limitations relating to the polysaccharide macromolecules and all molecules belonging to the polysaccharide family may be used in the method according to the invention. These may be natural or synthetic polysaccharides.

The polysaccharide macromolecule may be selected from pectins, alginates, alginic acid and carrageenans.

By the term alginate it is meant both alginic acid and its salts and derivatives such as sodium alginate. Alginates and in particular sodium alginate are extracted from various brown algae Phaeophyceae, primarily Laminaria such as Laminaria hyperborea; and Macrocystis such as Macrocystis pyrifera Sodium alginate is the most commonly found commercial form of alginic acid.

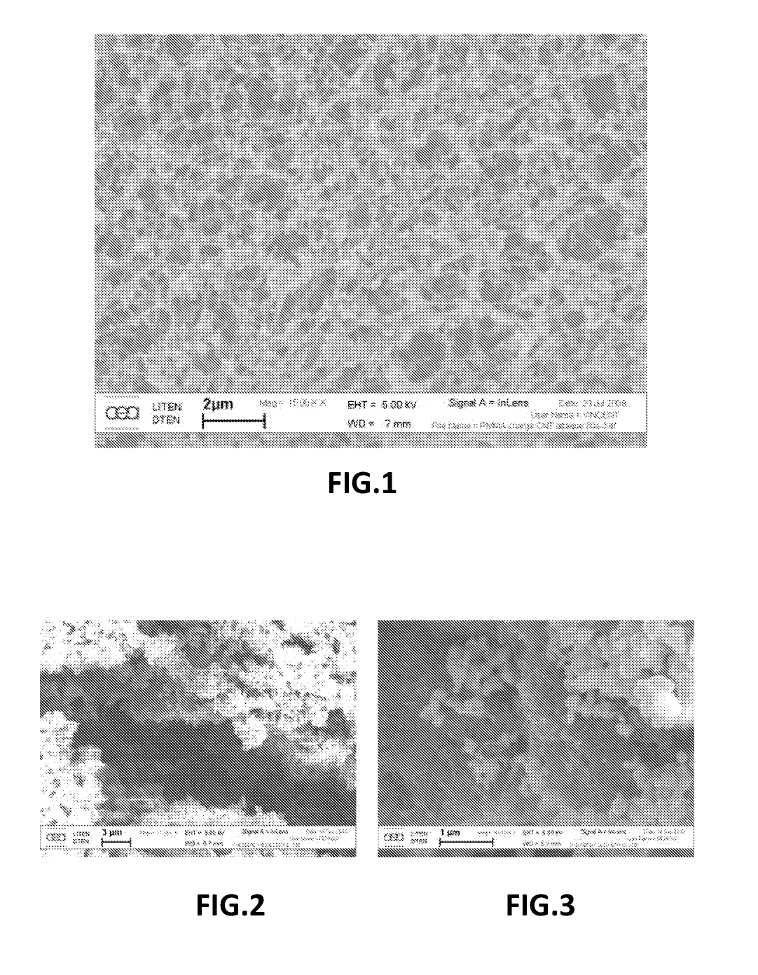

Alginic acid is a natural polymer with the empirical formula (C₆H₇NaO₆)ₙ made up of two monosaccharide units: D-mannuronic acid (M) and L-guluronic acid (G) (see FIG. 1 of application WO-A1-2010/012813). The number of basic alginate units is generally around 200. The proportions of mannuronic acid and of guluronic acid vary from one species of alga to another and the ratio of the number of M units to the number of G units can vary from 0.5 to 1.5, preferably from 1 to 1.5.

Alginates are linear unbranched polymers and are not generally statistical copolymers but depending on the alga from which they come, they are made up of sequences of similar or alternating units namely sequences GGGGGGGG, MMMMMMMM or GMGMGMGM.

For example, the M/G ratio for the alginate from Macrocystis pyrifera is about 1.6 whereas the M/G ratio for the alginate from Laminaria hyperborea is about 0.45.

Among the polysaccharides alginates from Laminaria hyperborea, Satialgine SG 500 could be cited, of polysaccharide alginates from Macrocystiis pyrifera of various lengths of molecules, the polysaccharides called A7128, A2033 and A2158 could be cited, which are generic alginic acids.

An alginate which may be used according to the invention is the alginate available from the CIMAPREM company under the name CIMALGIN® 80/400.

The polysaccharide macromolecule used according to the invention generally has a molecular mass of from 80000 g/mol to 500000 g/mol, preferably of from 80000 g/mol to 450000 g/mol.

The dispersion of nano-objects or nanostructures in the first solvent and dissolution of the polysaccharides may be simultaneous operations or may involve two consecutive operations, with the dispersion preceding the dissolution, or vice versa.

The dispersion of the nano-objects such as nano-particles or nanotubes, or nanostructures in the first solvent may be achieved by adding the nano-objects to the first solvent and subjecting the solvent to be action of ultrasound with an acoustic power density generally of from 1 to 1000 W/cm², for example of 90 W/cm², for a duration generally of from 5 minutes to 24 hours, for example of 2 hours.

The dissolution of the polysaccharides may be achieved simply by addition to the first solvent with stirring generally at a temperature of from 25° C. to 80° C., for example of 50° C., for a period generally of from 5 min to 24 hours, for example of 2 hours.

The concentration of nano-objects or nanostructures and the concentration of polysaccharides depend on the amount of nano-objects and of nanostructures to be coated relative to the amount of polysaccharide molecules.

The concentration of nano-objects in the first agglomerate, or gelled agglomerate, as well as the concentration of polysaccharides are generally less than or equal to 5% by mass, preferably less than or equal to 1% by mass of the mass of the solvent. More preferably still, the concentration of nano-objects and the concentration of polysaccharides are from 10 ppm to 5% by mass, more preferably still from 10 ppm to 1% by mass, and better still from 10 ppm to 0.1% by mass of the mass of solvent in the first agglomerate or gelled agglomerate.

The ratio of the number or of the quantity of macromolecules to the number of nano-objects in the first solution and as a consequence in the first agglomerate or gelled agglomerate is generally from 0.1 to 10, preferably equal to or close to 1.

This ratio between the amount, the number of polysaccharide macromolecules and the amount, the number of nano-objects or of nanostructures sets the level of dispersion or dispersion factor and the mean distance for the nanoparticles, or sets the unit cell for the network for nano-structures, nanowires, nanofibres and nanotubes.

The mixture produced from the dispersion of nano-objects or nanostructures in the first solvent, and the dissolution of the polysaccharides may then possibly undergo a centrifugation process in order to obtain an extrudable paste.

This extrudable paste is then processed during an extrusion step and used to form, after extrusion, an extruded material comprising an expanded three-dimensional “3D” structure, for example of carbon nanotubes, wherein silicon nanoparticles are homogeneously distributed as shown in FIG. 1.

It is only the processing in the extruder that allows the 3D network to be obtained since the cumulative low shear speeds are important.

Thus the pressure in the last shear zone which is generally between 50 and 80 bar at the head of the extruder is a significant factor for the three-dimensional structuring of the expanded network of carbon nanotubes.

It should be noted at this stage that there is as yet no contact made with the cations and cross-linking.

In a second step of preparation of freeze-dried capsules, gelled capsules, agglomerates are prepared (first capsules or first agglomerates) by bringing the first solution of dispersed nano-objects prepared during the first step described above, or the extruded materials prepared as described earlier, into contact with a second solution.

This second step for preparation of freeze-dried capsules is generally made as has been described in application WO-A1-2010/012813.

This second solution is a solution, in a second solvent comprising mostly water, of at least one soluble salt in water that is likely to release into the solution cations selected from monovalent, divalent and trivalent cations.

By the term solvent comprising in majority water, it is meant in general that the solvent of the second solution contains 50% by volume of water or more, preferably 70% by volume of water or more, and even more preferably more than 99% by volume of water.

The solvent may include, apart from the water in the proportions stated above, and when it does not comprise 100% water, at least one other solvent compound generally selected from alcohols, in particular aliphatic alcohols such as ethanol; polar solvents such as ketones for example acetone, and mixtures thereof.

The divalent cations may be selected from Cd²⁺, Cu²⁺, Ca²⁺, Co²⁺, Mn²⁺, Fe²⁺, and Hg²⁺.

The monovalent cations may be selected from Li⁺, Na⁺, K⁺, Rb⁺, Cs⁺, Ag+, Ti⁺, and Au⁺.

The trivalent cations may be selected from Fe³⁺, and Al³⁺.

The anion of the salt(s) may be selected from nitrate, sulphate, phosphate ions, halide ions such as chloride, bromide.

The solution may include only one salt or it may include several salts.

Advantageously, the solution includes several salts so that a mixture of cations may be released in the second solution.

Preferably, the solution includes a mixture of salts which may release into the solution a mixture of cations comprising at least one monovalent cation, at least one divalent cation and at least one trivalent cation.

A mixture of cations selected from the three families of monovalent, divalent and trivalent cations and preferably comprising at least one cation selected from each of the families allows the quantity of cross-linking nodes in the system to be controlled, and in particular allows this quantity of cross-linking nodes to be kept to a minimum in order to ensure the structural stability of the capsules, gelled agglomerates and then freeze-dried capsules, agglomerates.

In effect, the quantity of cross-linking nodes is a parameter which must be controlled as a function of the use that is made of the agglomerates and of their applications.

Bringing the first solution or extruded material into contact with the second solution is in general carried out under the following conditions:

In a first embodiment of this process for bringing them into contact, the solution of dispersed nano-objects or nano-structures or the extrudable paste falls drop wise into the second solution. In this case the size of the injector tip, nozzle is important since is controls the size of the gelled agglomerate. If too large the freeze-drying or extraction, for example of water, proceeds moderately well and the shrinkage is greater therefore dispersion is worse.

Too small and the agglomerates are freeze-dried perfectly, but the preparation time for these gelled agglomerates is too long. The optimum size of the nozzle, injector is for example between 0.5 and 2 mm.

Depending on the conditions for contact and the nature of the nano-objects or nanostructures, it is possible to manufacture spherical gelled agglomerates, capsules or even agglomerates which are gelled as filaments and drawn with controlled drawing ratios.

Herein, the preparation of spherical gelled agglomerates is given preference with a view to their use in a fluidised bed.

Spherical gelled agglomerate capsules may have a size defined by their diameter of from 100 μm to 5 mm, for example of from 2 mm to 3 mm or of from 4 mm to 5 mm.

With a nozzle, injector size of 0.5 mm, gelled capsules are obtained with a diameter of from 2 to 3 mm.

It is consequently possible to control the orientation of nano-objects or nanostructures in the gelled agglomerate which are aligned in the case of maximum drawing, or are aligned in a purely random manner but regularly distributed in a homogeneous manner in the case of spherical agglomerates.

It is also possible to form only one cross-linked skin and to maintain the interior of the first agglomerates in the liquid state. This may be achieved by “spraying” the cross-linking solution onto the liquid drop in formation before it separates from the nozzle. It is therefore possible to retain a high level of mobility of nano-objects inside the capsules.

The first agglomerates or gelled agglomerates obtained from the second step may be separated by any appropriate separation method, for example by filtration.

Gelled agglomerates such as spheres obtained from the second step may if necessary in be processed by impregnation, in a third step, with for example polyethylene glycol or any other water soluble polymer or monomer, in solution (as an example, for water the optimum concentration of polyethylene glycol is 20%). Examples of such polymers have already been given above.

Since these agglomerates, impregnated or not impregnated are generally mixed with the (second) cross-linking aqueous solution, a separation step generally follows, for example by filtering in a Buchner funnel before the gathered capsules are frozen for example by being immersed in liquid nitrogen. The instantaneous solidification minimises the salting-out of capsules from the solvent, such as water, maintaining maximum dispersal. This solidification, freezing in fact forms the first part of the freeze-frying process. The frozen capsules may if required be stored in a freezer before carrying out the sublimation and subsequent processing operations.

This solidification, freezing of agglomerates, which may be impregnated if required, is followed by a sublimation step which forms the second part of the freeze-drying processing. During this sublimation step, under the effect of vacuum the frozen solvent, such as ice, is eliminated from the interior of the capsules and if required the polymer such as polyethylene glycol is crystallised.

The agglomerates may therefore be placed, for example, in a chamber cooled to a minimum of −20° C. and under a hard vacuum (10⁻³-10⁻⁷ mbar) in order to sublimate the frozen solvent such as ice and if required crystallise the polymer present such as polyethylene glycol.

Optionally, the freeze-drying processing may comprise a third part during which the agglomerates are cold-dried.

It should be noted that this freeze-drying step may be carried out even if the first solvent does not include any polymer of monomer and/or if the gelled agglomerates are not impregnated in a third step by a polymer or monomer, in particular a water soluble polymer or monomer.

The freeze-drying may be carried out irrespective of the solvent of the gelled agglomerates, be it water or any other solvent or mixture of solvents. Generally however, the gelled agglomerates solvent must contain in majority water.

At the end of freeze-drying, there is substantially no longer any solvent in the freeze-dried agglomerates. The solvent concentration is generally less than 0.01% by mass.

If the solvent of the gelled agglomerates consists of water, the water content of the freeze-dried capsules, agglomerates is generally less than 0.01% by mass.

The capsules, gelled agglomerates obtained at the outcome of this second step retain their shape and generally 90% of their volume after freeze-drying.

It should be noted however that storing these freeze-dried capsules in air may cause a rise in moisture levels once more of the order, for example, of 6% by mass.

The organisation of the nano-objects, namely, preferably CNTs, and silicon nanoparticles is preserved in the freeze-dried capsules.

The freeze-dried capsules generally have a size defined by their largest dimension, such as their diameter in the case of spherical capsules, of from 2 to 3.5 mm, for example of from 3 to 3 mm. Spherical freeze-dried capsules which exhibit such a diameter are easily fluidised but are not easily entrained and do not cause fouling of the reactor.

Generally the freeze-dried capsules are made up of as a percentage by mass of from 10% to 60% for example 40% of polysaccharide macromolecules, of from 30% to 89% for example 35% of silicon nano-objects, for example silicon nanoparticles, and of from 1% to 10% for example 5% of carbon nano-objects for example carbon nanotubes.

FIGS. 2 and 3 show the internal organisation of freeze-dried capsules obtained by the method in application WO-A1-2010/012813 optionally optimised as regards the size of the nozzle so that the size of the first gelled capsules before freeze-drying are preferably from 4 to 5 mm for spherical capsules, and as regards the technique for mixing nanotubes and silicon nanoparticles, so that the silicon nanoparticles are distributed in a homogeneous manner in a three-dimensional “3D” network or expanded network of carbon nanotubes.

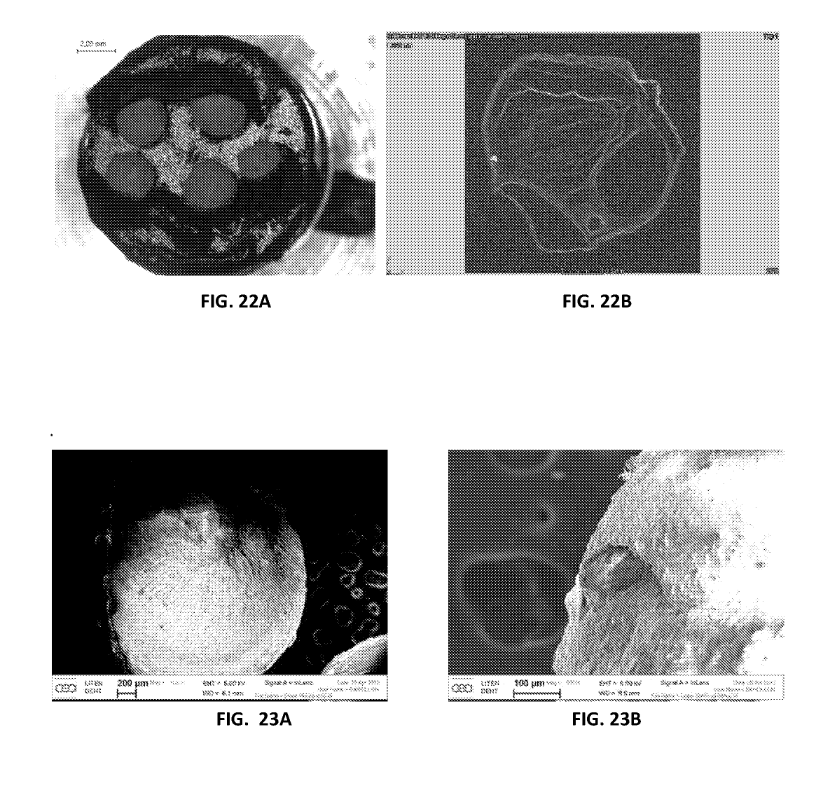

Freeze-dried composite capsules before the synthesis of the silicon nano-objects are represented in FIGS. 22A and 22B.

These are generally hollow spheres with a diameter, for example, of 3+/−0.1 mm composed, for example, of carbon nanotubes, of silicon nanopowder and of alginate cross-linked with calcium.

5 freeze-dried capsules are thus arranged on a sample support for an SEM microscope. They are held by a carbon paste in order to allow observation by SEM.

The carbon nanotubes are, for example, nanotubes of the Graphistrength® brand, which are multi-wall nanotubes of purity greater than 90%, with a mean diameter of between 10 nm and 15 nm and a mean length of 7 μm.

The specific surface area of these nanotubes is between 20 m²/g and 70 m²/g.

The silicon is, for example in the form of powder from the S'tile® company. The initial particle size diameter of this silicon powder is 310 nm made up of practically spherical particles with small agglomerates of between 1 μm and 5 μm.

The surface area is estimated at 14 m²/g. The alginate is a commercial alginate manufactured by the CIMAPREM company. The grade used is CIMALGIN® 80/400.

The freeze-dried capsules generally have a polymorphic structure of cells delimited by walls formed by the cross-linked alginate. Inside the volume delimited by the walls is the network of carbon nanotubes and silicon particles. The same type of walls form the external shell of the freeze-dried capsule. The photographs of the external surface of the capsule in FIGS. 23A and 23B show a smooth surface made up of alginate gelled with calcium. The freeze-drying reveals a few fissures which allows the organisation of the carbon nanotubes and the silicon to be seen in the polymorphic volumes of the cells.

In the interstices of the fissures, two types of organisation can be seen in the polymorphic volume of the cells of the composite capsules. (FIGS. 24A and 24B): the first relates to the carbon nanotube-rich zone which forms an expanded network with practically no silicon particles. The second relates to zones rich in silicon particles often placed on the network of carbon nanotubes. This characteristic shows a heterogeneity in the organisation of the freeze-dried material which leads after synthesis to a composite material which possesses the characteristics described later.

The freeze-dried capsules prepared as described above are placed in a heated chemical vapour deposition (“CVD”) reactor under vacuum. This reactor is equipped with means for heating and means for creating a vacuum, generally a primary vacuum, inside the chamber.

A vector or carrier gas is injected into the reactor to form a fluidised bed of the freeze-dried capsules.

The reactor is generally designed in such a way that the carrier or vector gas can be injected using two zones which are independent of each other, in particular by using appropriate means of regulation: namely a central zone and a peripheral zone.

The reactor is in addition designed so that the freeze-dried capsules are placed in the lower part, the bottom, of the reactor near to or on the lower wall or base. The lower part of the reactor generally has a cone shape that may be referred to as the fluidisation cone.

Consequently the reactor is also generally designed so that the vector or carried gas used for fluidisation of the freeze-dried capsules is introduced through the bottom of the reactor in the peripheral zone, and so that the current of vector or carrier gas generally takes a rising direction in order to ensure fluidisation of the freeze-dried capsules.

The freeze-dried capsules are sufficiently light, with an apparent (bulk) density generally less than 0.1 g/cm³, for fluidisation to be generated only through the periphery.

The carrier gas may be selected from hydrogen, argon and mixtures thereof.

The flow rate of the carrier or vector gas is generally chosen so that it allows fluidisation of the fluidised capsules without, however, causing the capsules to be entrained from the fluidised bed.

The flow rate of the carrier or vector gas may be from 0.3 to 15.0 L/h.

One or more silicon containing silicon precursor(s) compound(s) are in addition introduced into the reactor.

Generally said precursor compound or compounds are introduced through the bottom of the reactor in the central zone of the fluidisation cone.

The silicon-containing precursor compound or compounds may be selected from silane, trichlorosilane and tetra alkyl silanes (whose alkyl groups which are identical or different generally have 1 to 4 C atoms) such as tetramethylsilane.

The precursor compound or compounds are generally introduced into the central zone of the reactor at a constant flow-rate, for example of from 0.1 l/hr to 1 l/hr throughout the entire period of processing of the capsules, namely throughout the deposition operation.

The duration of this period is generally from 0.5 hours to 4 hours, for example 2 hours.

A temperature setting of for example 900° C. to 1200° C. is established in the reactor, prior to the operation for deposition of silicon on the carbon nano-objects such as carbon nanotubes, which coincides with the injection of the precursor compounds. This temperature is maintained throughout the entire duration of the processing, that is, of the operation for the deposition of silicon on the carbon nano-objects such as carbon nanotubes.

In other words, when the setting temperature reaches the value specified earlier, for example 900° C., the precursor compounds are introduced.

The pressure developed inside the reactor during the deposition operation is generally a pressure of from 1 to 50 mbar and more specifically 5 mbar.

More specifically there is a primary vacuum, that is, the pressure in the reactor is of the order of, for example, 10⁻¹ mbar before the start of the processing of the deposition operation, and this pressure rises to a value which is in the range specified earlier, for example to a value of about 5 mbar during the deposition operation, process.

The temperatures of 900° C. to 1200° C. mentioned above are those which allow Si and SiO₂ to be deposited on carbon nano-objects, for example carbon nanotubes.

For certain applications of the material according to the invention and in particular the preferred application according to the invention in negative electrodes of batteries, it is necessary to deposit only silicon on the carbon nano-objects.

At 900° C. under vacuum, the vapour pressure of silicon is only 3.10⁻⁸ Pa whilst the diffusion speed is negligible.

The reaction Si+SiO₂->SiO+Si is used to generate an atmosphere of SiO and of Si radicals within each capsule itself acting as a microreactor wherein SiO successively evaporates and condenses on all the surfaces of the nano-objects, for example the carbon nanotubes.

More accurately, during this reaction, the SiO₂ is reduced to the form SiOx where 0<x<2.

During this cyclic process, there is a swelling and coalescence of the grains of silicon with the formation of material made up mostly of Si and of SiOx (where 0<x<2) which forms a continuous structure around the nano-objects, for example around the network of carbon nanotubes.

At the end of the operation of deposition on the nano-objects, for example on the carbon nano-tubes, the capsules which comprise nano-objects for example carbon nanotubes, coated with Si and SiOx are, after cooling, generally to ambient temperature, extracted from the CVD reactor.

The carbon nano-objects, for example carbon nanotubes, are coated with Si and with SiOₓ generally in a proportion of ⅔ silicon and ⅓ SiOₓ (where 0<x<2).

After the deposition operation on the nano-objects, for example carbon nanotubes, a deoxygenation treatment is carried out. This deoxygenation treatment (oxygen removal) in particular reduces SiOₓ to Si.

This deoxygenation treatment is generally carried out in an alumina crucible covered with graphite at a temperature of from 1200° C. to 1400° C., for example of 1350° C. for a period of from 10 min to 2 hours, for example of 20 minutes, in an atmosphere of pure hydrogen, or in an atmosphere of inert gas, such as argon with added hydrogen, for example in an atmosphere of argon with 5% by volume hydrogen.

The material eventually obtained has the form of an assembly of porous capsules with a dense shell.

By the term “porous capsules” it is meant that the interior of the capsules is porous with a porosity of the interior of the capsules generally greater than 50%.

By the term “dense shell” it is meant that the silicon shell possesses a density generally of from 1 to 3 g/cm³, preferably 1 to 2 g/cm³ measured using helium pycnometry.

When a amorphous carbon sub-shell is present, the density of the shell and of the sub-shell is generally 1 to 3 g/cm³, preferably 1.8 to 2.5 g/cm³, yet more preferably 1.9 g/cm³ to 2.3 g/cm³, measured using helium pycnometry.

The apparent (bulk) density of the capsules is generally 0.1 g/cm³ to 0.2 g/cm³, for example 0.112 g/cm³.

The chemical composition of the material has been determined using IGA and GDMS.

The BET surface area of the capsules may generally be between 20 and 70 m²/g depending on the manufactured batches.

The capsule is generally in the form of a hollow sphere or a quasi (near) sphere.

The capsule generally has a larger dimension, such as a diameter, of from 0.5 mm to 2.5 mm, preferably of from 0.5 mm to 2 mm, even more preferably of from 1 mm to 2 mm, and better still from 1.5 mm to 2 mm.

In the case where there is a carbon sub-shell present, the capsules generally have a larger dimension, such as a diameter, of from 0.5 to 2.5 mm, preferably of from 1.5 mm to 2.5 mm, for example of 2 mm.

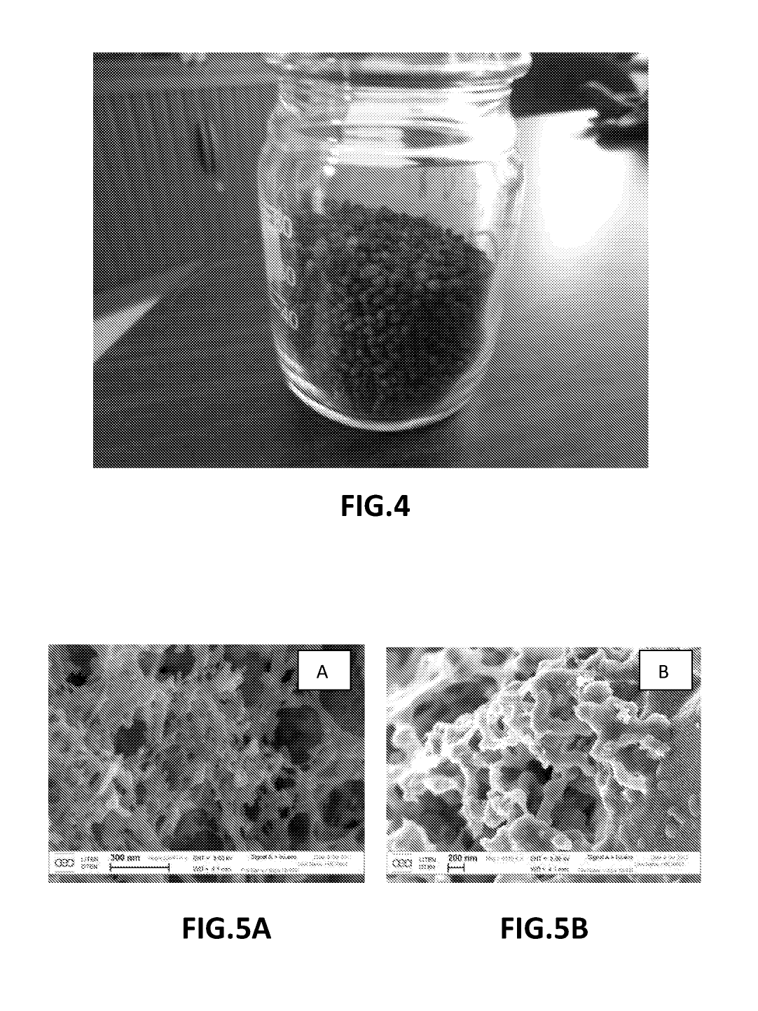

The colour of the capsules can range from pale ochre to dark ochre (FIG. 4).

These capsules comprise carbon nano-objects, for example carbon nanotubes, in majority covered with silicon with possibly a few traces of SiOₓ (where 0<x<2).

By the term “a few traces”, it is meant that the quantity of SiOₓ is generally less than 0.5% by mass.

The exterior of the capsules is formed by a dense shell consisting of silicon with a thickness of from 50 nm to 500 nm, preferably of from 100 nm to 500 nm, and more preferably of 100 nm to 200 nm.

This shell plays a role that may be described as “nano-security” since is it is generally continuous and confines the silicon nano-objects, for example the silicon nanoparticles, and the carbon nano-objects, for example the carbon nanotubes inside the capsules.

The interior of the capsules is formed, for example, of an expanded three-dimensional network of CNTs coated with silicon as shown in the photos in FIGS. 5A and 5B.

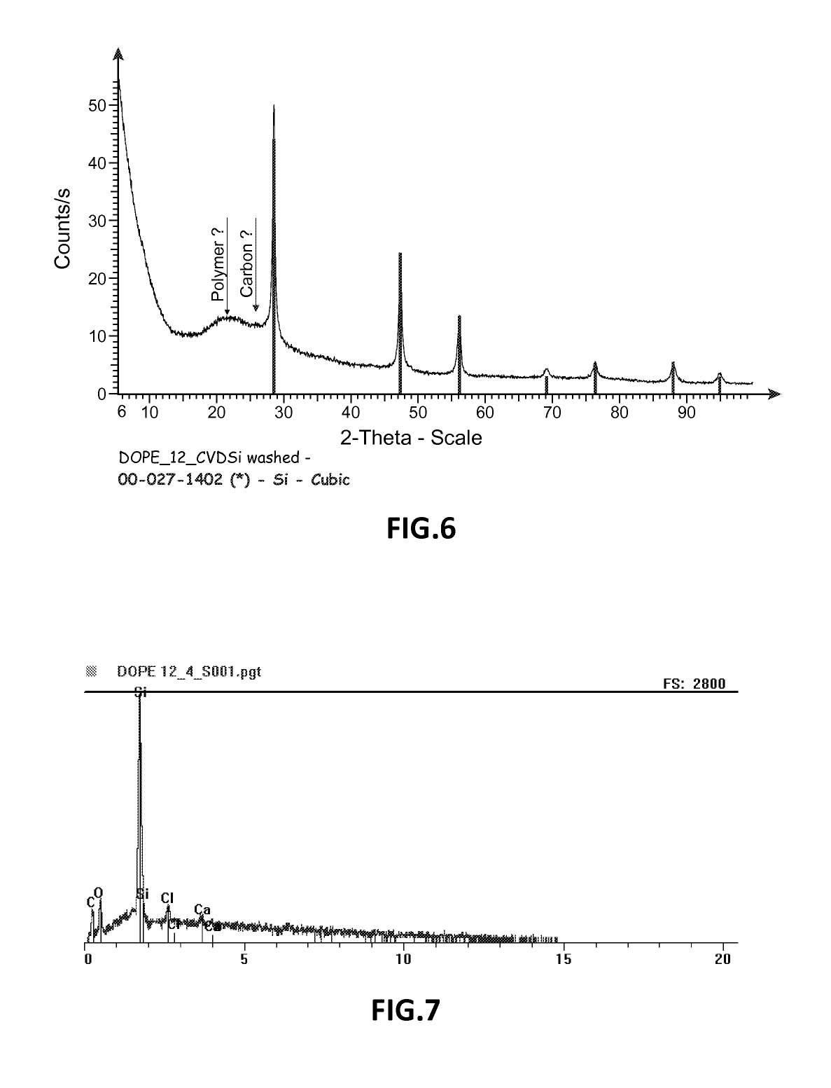

The X-ray analysis and the “EDS” spectrum of the capsules after the CVD processing confirm the presence in majority of cubic silicon both at the capsules scale (FIG. 6) and at the nanostructure scale.

The composite capsules may optionally comprise a thin shell of amorphous carbon partially or totally coated with the silicon shell.

Two types of nano-objects may be found in the interior, namely: “silicon nano-objects” and “carbon nano-objects”.

The apparent density of the composite capsules may be 0.112 g/cm³.

The material which constitutes the composite capsules generally has, for example, a density of between 1.9 g/cm³ and 2.3 g/cm³ (measured using helium pycnometry).

The chemical composition of the materials has been determined using IGA and GDMS.

The BET developed surface area may for example be between 20 and 70 m²/g depending on the manufactured batches.

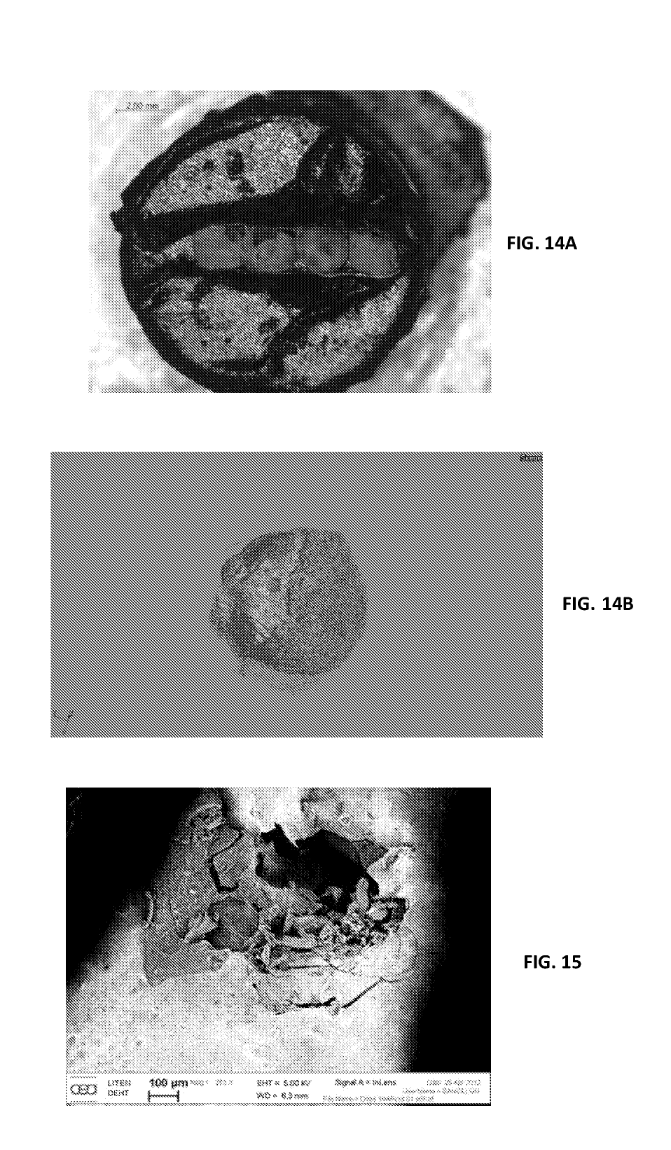

Since the synthesis is not homogeneous, the density of the composite capsules varies according to the silicon content. 4 composite capsules according to the invention are therefore represented in FIG. 14A. They are surrounded by a black conductive carbon paste in order to enable them to be observed using electron microscopy (SEM). They are arranged on an SEM sample holder.

It can be seen from the X-ray tomography plate (FIG. 14B) that there is a practically vertical demarcation present. The right hand part is characterised by the presence of the protective shell of the composite capsule whereas the left hand part of the X-ray tomography plate (FIG. 14B-light grey zone) represents a part without a shell. The thickness of the shell is estimated for example to be between 50 nm and 200 nm, and it is formed by a carbon containing structure completely or partly covered with amorphous silicon.

Since this protective shell is fragile, it frequently happens that during synthesis fragments of the composite capsule become detached (FIG. 15).

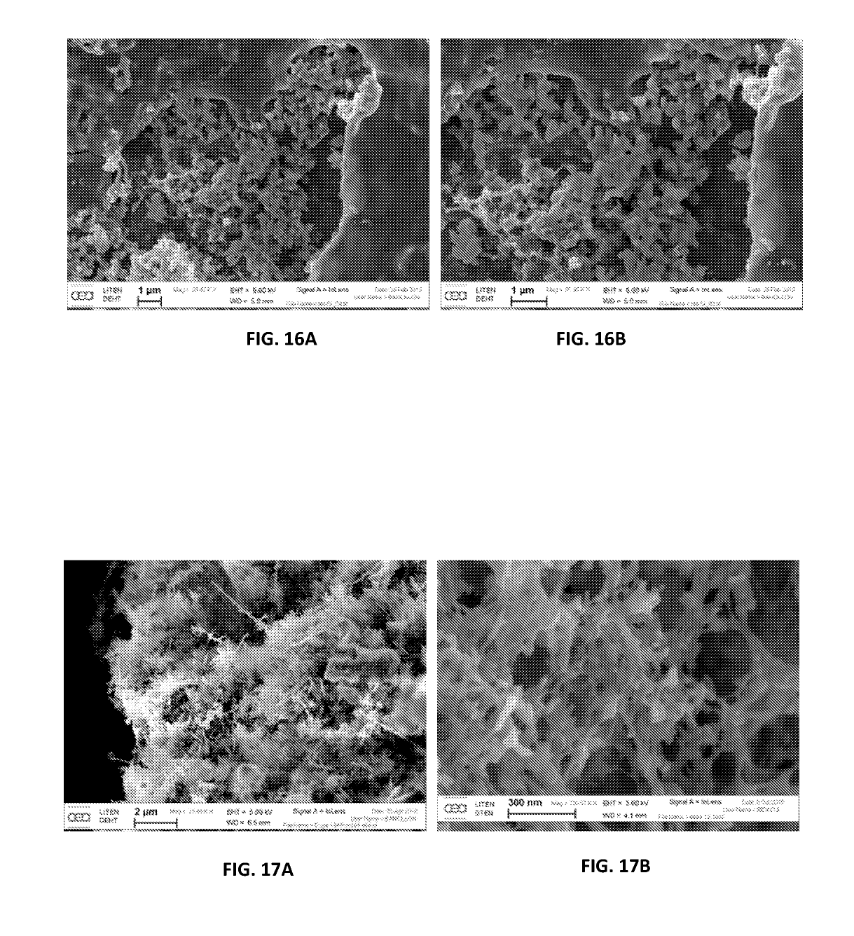

FIG. 16 shows this point in detail since the observation (FIG. 16A) is made on the zone left after the detachment of such a fragment. Around the detached zone we can see an image of the amorphous carbon shell (sub-shell). Around the fissured zones of the shell we can see local deposits of amorphous silicon in the form of small light grey drops which have become detached from the blacker background of the carbon shell surface. This observation proves that these cracks existed during the synthesis and that a part of the SiO formed by the reaction between the Si and the SiO₂ escapes through these cracks.

Inside the composite capsule there are various zones which indicate heterogeneity of the material.

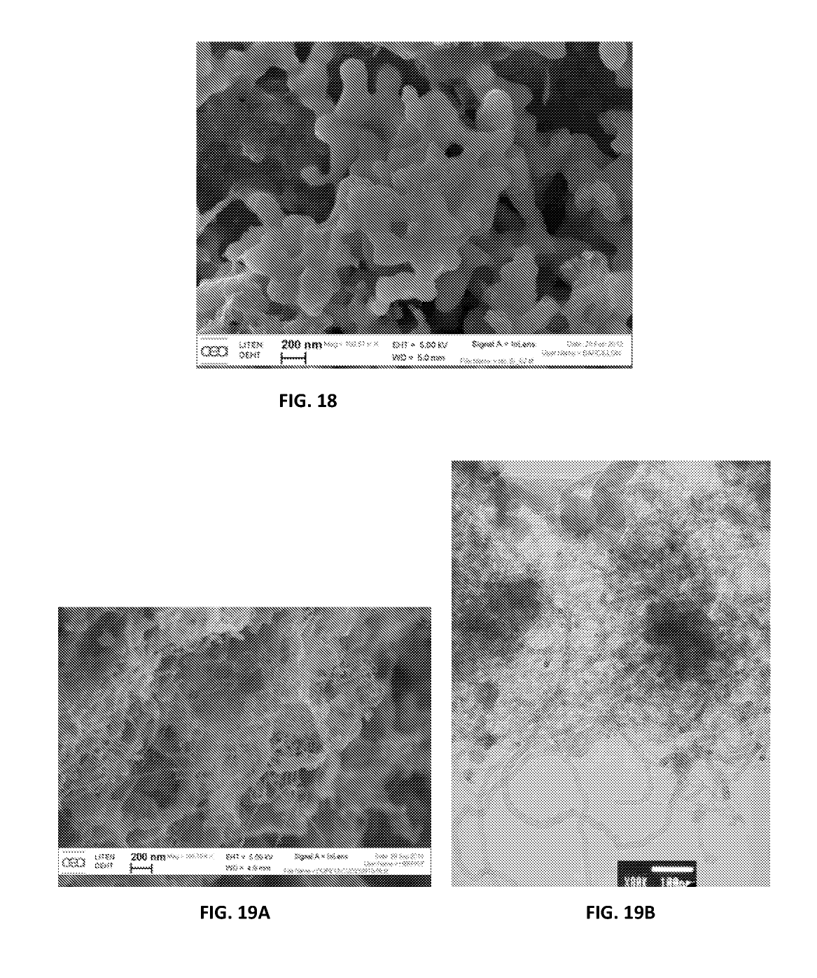

The photograph in FIG. 16B shows both a zone rich in carbon nanotubes covered with amorphous silicon and a zone rich in silicon particles which partially form locally a mesoporous silicon nanostructure. These two zones reveal two types of silicon nano-objects, which need to be defined. FIGS. 17A and 17B show the first type of silicon nano-objects, the most desirable for the batteries application. FIG. 18 shows the second type of silicon nano-object indicating a non-optimisation of the freeze-dried material used in the manufacture of composite capsules.

The first type of “silicon nano-object” is that consisting of carbon nanotubes covered with amorphous silicon (FIGS. 17A and 17B). The analysis of the plates shows that the amorphous silicon covering of the network of carbon nanotubes is not homogeneous. Within the composite capsules, a variety of silicon nano-objects with atypical shapes and variable thicknesses are observable. In all cases the silicon nano-objects are recognised by their underlying organisation, which is that of the network of carbon nanotubes.

In the case where the organisation of silicon particles in the freeze-dried composite capsules is not homogeneous, zones exist where there are a concentration of silicon particles and an absence of carbon nanotubes. These zones produce the second type of silicon nano-objects, visible in FIG. 18.

In these zones the silicon nano-objects are made up solely of silicon particles which are partially fritted together forming a mesoporous network. These nano-objects are distinguished from the previous ones by the absence of carbon nano-tubes within their nanostructure.

The carbon nano-objects are carbon nanotubes which have not been covered with amorphous silicon, often visible in agglomerates of carbon nanotubes (FIGS. 19A and 19B).

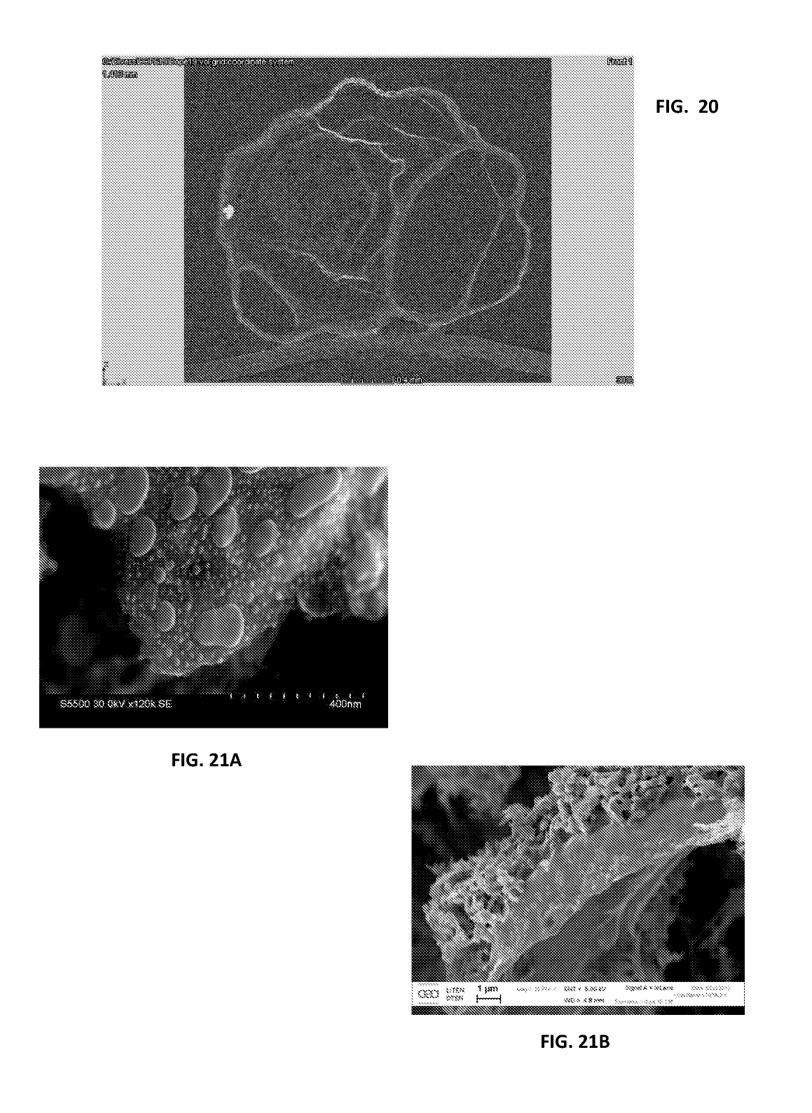

As shown in the X-ray tomography of the interior of the composite capsules in FIG. 20, this interior of the capsules is divided into different domains inside which the synthesis of the nano-objects described previously is carried out. These domains are separated by walls of amorphous carbon coated with silicon after the fashion of the external shell of the capsule in the case where the latter includes a silicon shell and an amorphous carbon sub-shell.

The walls have variable shapes and thicknesses and are characterised by smooth surfaces which are partially or completely covered with amorphous silicon.

FIGS. 21A and 21B show an example where the surfaces of the walls are partially covered. Drops of silicon can be observed. Silicon nano-objects are generally fully integrated with the walls and fill the volume delimited by said walls.

The composite material prepared according to the invention as has been described above may be used as the electrochemically active material in any electrochemical system.

More precisely, the composite material prepared according to the invention may in particular be used as an electrochemically active positive or negative electrode material in any electrochemical system, in particular in any non-aqueous electrolyte electrochemical system.

This positive or negative electrode includes, apart from the electrochemically active positive or negative electrode material as defined above, a binder which is generally an organic polymer, if required one or more electronic conductive additives and a current collector.

The organic polymer may be selected from polytetrafluoroethylene (PTFE), poly(vinylidene fluoride) (PVDF), PVDF-PHF (propylene hexafluoride copolymer); carboxymethylcellulose; and elastomers such as CMC-SBR (carboxymethylcellulose-styrene butadiene rubber).

The electronic conductive additive that may be required may be selected from metal particles such as Ag particles, carbon black, carbon fibres, carbon nanowires, carbon nanotubes and electronically conductive polymers and mixtures thereof.

The current collector generally takes the form of a sheet of copper, nickel or aluminium.

The electrode generally includes from 70% to 94% by mass of electrochemically active material, from 1% to 20% by mass, preferably from 1% to 10% by mass, of the binder, and if required from 1% to 15% by mass of the electronic conductive additive(s).

Such an electrode may be prepared in a conventional manner by forming a suspension, paste or ink with the electronically active material, the binder, if required the conductive additive(s) and a solvent, by depositing, coating or printing this suspension, paste or ink onto a current collector, by drying the deposited ink, paste or suspension and by calendering or pressing the deposited, dried paste or ink and the current collector.

In order to form a suspension, paste or ink the capsules, generally spherical, of the material according to the invention are advantageously crushed in order to facilitate the forming into a suspension, paste or ink.

Crushing simply using a mortar or other means may be carried out.

Alternatively the capsules can be passed through an extruder with the ink binder, suspension or paste and if required conductive additive(s) and a solvent in order to make at the same time the ink, suspension or paste wherein the electrochemically active material is incorporated.

The ink, paste or suspension may be applied using any appropriate method, such as coating, layering, rotogravure, flexographic printing, offset printing.

The electrochemical system may be in particular a non-aqueous electrolyte rechargeable electrochemical battery such as a lithium battery, and more specifically a lithium ion battery which apart from the positive or negative electrode as defined earlier comprising as an electrochemically active material the composite material according to the invention, includes a negative or positive electrode which does not include the composite material according to the invention, and a non-aqueous electrolyte.

The negative or positive electrode, which does not include as an electrochemically active material the composite material according to the invention, includes an electrochemically active material which is different to the composite material according to the invention, a binder, if required one or more electronic conductive additives and a current collector.

The binder and if required the electronic additive(s) have already been described above.

The electrochemically active material of the negative or positive electrode which does not include the composite material according to the invention as an electrochemically active material may be selected from all the materials known to the man skilled in the art.

Thus when the composite material according to the invention is the electrochemically active material of the negative electrode, then the electrochemically active material of the positive electrode may be selected from lithium metal and any material known to the man skilled in the art in this technical field.

When the electrochemically active material of the positive electrode is formed by the material according to the invention, the electrochemically active material of the negative electrode may be made from known material which is adaptable by the man skilled in the art.

The electrolyte may be solid or liquid.

When the electrolyte is liquid, it is made up for example of a solution of at least one conductive salt such as a lithium salt in an organic solvent and/or an ionic liquid.

When the electrolyte is solid, it includes a polymer material and a lithium salt.

The lithium salt may be selected, for example, from LiAsF₆, LiClO₄, LiBF₄, LiPF₆, LiBOB, LiODBF, LiB(C₆H₅), LiCF₃SO₃, LiN(CF₃SO₂)₂ (LiTFSI), LiC(CF₃SO₂)₃ (LiTFSM).

The organic solvent is preferentially a solvent which is compatible with the electrode constituents, of relatively low volatility, aprotic and relatively polar. Ethers, esters and mixtures thereof may be cited as examples.

The ethers are selected in particular from linear carbonates such as dimethyl carbonate (DMC), diethyl carbonate (DEC), ethyl methyl carbonate, dipropyl carbonate (DPC), cyclic carbonates such as propylene carbonate (PC), ethylene carbonate (EC), and butylene carbonate; alkyl esters such as formates, acetates, propionates and butyrates; gamma butyrolactone, triglyme, tetraglyme, lactone, dimethylsulphoxide, dioxolane, sulfolane and mixtures thereof. The solvents are preferentially mixtures including EC/DMC, EC/DEC, EC/DPC and EC/DMC.

The battery may in particular be in the form of a button battery.

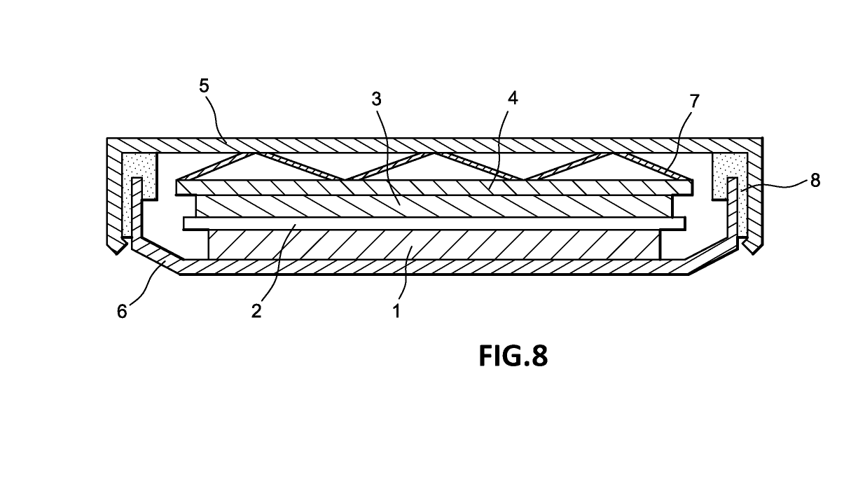

The various elements of a button battery made of stainless steel 316L are described in FIG. 8.

These elements are as follows:
the upper (5) and lower (6) parts of the stainless steel case,
the polypropylene seal (8),
Stainless steel shims (4), which serve, for example, to cut out the lithium metal then later to ensure there is good contact between the current collectors and the external parts of the battery,
a spring (7), which ensures good contact between all the elements,
a microporous separator (2) impregnated with electrolyte,
electrodes (1) (3).

The invention will now be described with reference to the following examples, given as illustrations and non-restrictively.

### EXAMPLES

### Example 1

In this example a silicon/carbon nanotube “CNT” composite material according the invention is prepared using the method according to the invention.

The manufacture of the Si/CNT composite material according to the invention comprises 4 steps: (a) Manufacture of the CNT/Si assembly, (b) Manufacture of CNT/Si capsules, (c) Chemical vapour deposition “CVD” of silicon, (d) Heat treatment.

a) Manufacture of 120 g of Self-Assembled CNT/Si:

To manufacture 120 g of self-assembled CNT/Si, 100 g de silicon with a particle size distribution of less than 500 nm is required (the material used is commercial silicon from the S'tile® organisation), with 5 litres of deionised water, 550 ml of ethanol and 10 g of carbon nanotubes.

The carbon nanotubes used are multi-walled carbon nanotubes from the Arkema® company.

Step a) itself includes sub-steps a1) to a4).

a1) the method starts by pre-dispersing the silicon nanopowders by wetting 100 g of silicon with 500 ml of ethanol et and incorporating them in 4 litres of deionised water.

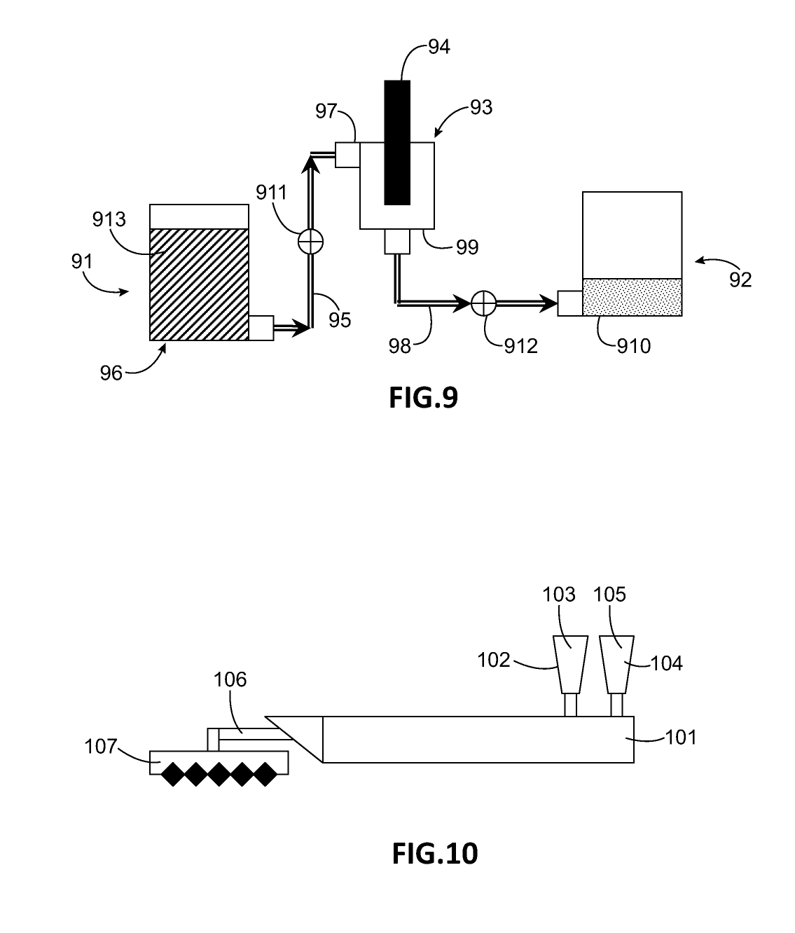

Then the silicon nanoparticles are dispersed using the ultrasound device represented in FIG. 9.

This device comprises a first (91) and a second (92) large capacity container, an open reactor (93) equipped with an ultrasound rod (94), a first set of pipework (95) connecting the base (96) of the first container (91) to the top (97) of the reactor (91), a second set of pipework (98) connecting the base (99) of the reactor (91) to the base (910) of the second container (92) and two pumps (911, 912) located respectively on the first and on the second set of pipework (95, 98).

The pre-dispersed silicon nano-particles (913) are placed in the first container.

The pump flow rate is regulated at for example 50 ml/min and the capacity of the reactor containing the ultrasound rod is, for example, 100 ml.

The characteristics of the ultrasound generated are, for example, as follows: 200 Watts, 24 kHz.

Under the conditions specified above, all of the silicon nanoparticles are dispersed in 1 hour 20 mins.

The dispersion of silicon nanoparticles thus prepared is magnetically stirred whilst the carbon nanotube dispersion is prepared as is described below.

a2) the carbon nanotubes are pre-dispersed by wetting 10 g of CNT with 50 ml of ethanol. The mixture is then dispersed in 1 litre of deionised water using the same device (FIG. 9) and under the same conditions as for the silicon. This second dispersion is formed in 20 minutes.

a3) 10 g of alginate are incorporated in the carbon nanotube dispersion prepared in sub-step a2), using a disperser or homogeniser, for example Ultra-turrax® equipment operating for example at 1000 rpm, that is a circular velocity of 9 m/s.

Under these conditions the mixing time is 10 minutes.

The dispersion obtained is kept stirred under magnetic stirring.

It should be noted that the alginate incorporated at this stage acts as a dispersant.

a4) the dispersion of carbon nanotubes prepared in preceding sub-step a3) is incorporated in the dispersion of silicon nanoparticles prepared during the first sub-step a1) and the dispersion obtained is kept stirred under magnetic stirring.

The auto-assembly of the CNT-Si system occurs automatically during the magnetic stirring.

At the end of sub-step a4) therefore capsules are obtained made up of self-assembled silicon nanoparticles, of CNTs and a small amount of alginate.

All of the self-assembled dispersion is then frozen and freeze-dried.

b) Manufacture of 300 g of Freeze-Dried Self-Assembled CNT/Si Capsules

In this step 300 g of capsules are manufactured from 120 g of self-assembled CNT-Si powder, 180 g of alginate and 6.7 litres of deionised water.

In other words, during this step the capsules obtained at the end of step a) (at the end of sub-step a4)) are mixed with a greater quantity of alginate, for example in a blender, such as an extruder, and these capsules are cross-linked by ions when this mixture runs from the mixer into a bath containing the ions.

First 180 g of alginate is wetted in 500 ml of ethanol and the alginate thus wetted by the alcohol is mixed with 6.7 litres of water.

This mixture of water and alginate is introduced into a conventional mixer.

This conventional mixer may be a co-rotating twin screw extruder (101) such as that represented in FIG. 10.

This extruder (101) is equipped with a first hopper (102) through which the mixture of water and alginate (103) prepared as described above is introduced, and a second hopper (104) through which a powder of CNT and of Si (105) is introduced; more accurately, the freeze-dried self-assembled dispersion prepared during step a4).

The extrusion allows the self-assembled nanostructure to expand, in order to achieve the optimum dispersion and to break up the last agglomerates.

The mixture of the various components introduced through the two hoppers (102, 104) is carried out using the co-rotating twin screw extruder (101) and the capsules are generated directly at the outlet of the extruder (106) by a special “Shower Rose” type extruder head (107) for forming calibrated drops of capsules.

These calibrated drops fall directly into a bath containing 10 litres of deionised water and 100 g of CaCl₂.

7 kilograms of gelled capsules are recovered by filtration and frozen before being freeze-dried at −96° C. under a vacuum of 0.0026 mbar.

At the end of the freeze-drying process, 300 g of freeze-dried capsules have been manufactured.

The final composition of these capsules is 120 g of self-assembled CNT-Si in a proportion by mass of 10%/90%, and 180 g of alginate.

c) Chemical Vapour Deposition (“CVD”) of Silicon

The capacity of the CVD reactor is 225 cm³, which corresponds to 15 g of freeze-dried capsules.

The freeze-dried capsules are loaded into the reactor and they are fluidised by the hydrogen in the peripheral zone at the flow-rate of 7 litres/hr. The oven is then heated until a temperature of 900° C. is achieved.

At 900° C., the TriChloroSilane (TCS) injected at a flow rate of 0.511/h. After 1 hour 30 minutes of CVD deposition the injection is stopped.

The yield of the operation, defined as the ratio between the mass of the capsules introduced into the reactor and the mass of the capsules after CVD processing is 70%.

From 300 g of self-assembled and freeze-dried capsules, it is possible to manufacture 210 g of active material.

d) Heat Treatment of Capsules Prepared Using CVD, with Silicon Shells.

The flow rate of hydrogen for fluidisation is increased to 15 litres/hr in the peripheral zone of the reactor or oven which is heated at the same time to reach a temperature of 1355° C.

The heat treatment lasts 20 minutes, then the reactor is cooled, generally to ambient temperature, and the nano-structured nanomaterials which are the subject of this invention are removed from the reactor and characterised (see FIGS. 4, 5A, 5B, 6, 7).

### Example 2

In this example a negative electrode is prepared with the material according to the invention prepared in example 1.

The preparation of the negative electrode with this material is achieved in two steps: a) Extrusion and refining of the electrode material; b) Spreading, drying and calendering of the negative electrode material.

a) Extrusion and Refining of the Electrode Material:

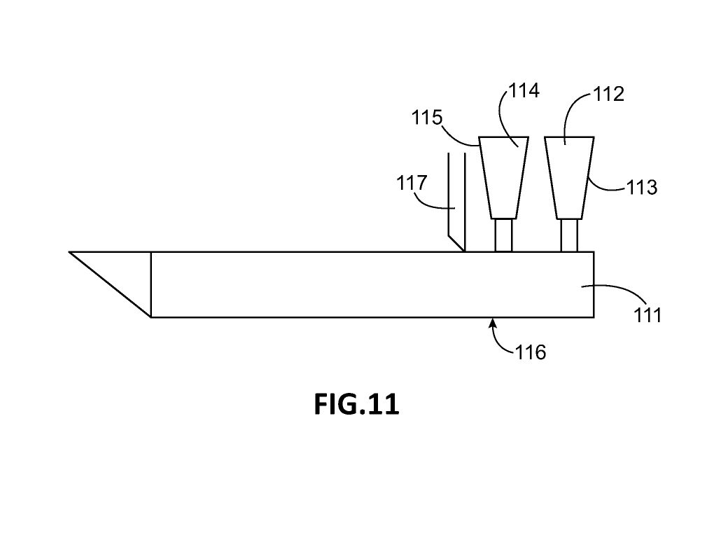

The extrusion operation is carried out in a twin-screw extruder (111) represented in FIG. 11.

This extrusion operation is carried out at ambient temperature.

First of all 100 g of material according to the invention (112) is taken, prepared in example 1, in a first metering feeder (or hopper) (113) with which the extruder is equipped (111).

The fine powders such as 20 g of vapour-grown carbon fibres “VGCF” (conductive material), 21 g of alginate or of Carboxymethyl Cellulose (“CMC”) (as binders), are dry-mixed mechanically and placed (114) in the second metered feeder (115) that the extruder is equipped with (111).

Both these metered feed units (113, 115) are positioned on the first transport part (116) of the extrusion twin-screw.

At the first shear-zone of the twin-screw, water (117) is introduced with a flow-rate adjusted to obtain a paste with a viscosity at rest of between 1000 Pa·s and 10000 Pa·s.

After the first extrusion the mixture is once more extruded either at ambient temperature or at a temperature of between 40° C. and 80° C. in order to gel the electrode material and to augment the elastic properties of the material.

In order refine the ink and to reduce the agglomerates, preferably to a size of less than 10 μm, the material is passed once through a triple-roller whose gaps have been reduced as much as possible for the equipment.

b) Coating, Drying and Calendering:

For an ink viscosity of between 10 Pa·s and 100 Pa·s, and for shear speeds of between 10 s⁻¹ and 100 s⁻¹, the coating speed must be between 10⁻³ m/s and 10⁻² m/s for coating thicknesses of between 100 μm and 300 μm.

In the example described here, the viscosity was adjusted to 50 Pa·s, the spreading speed is 5.10⁻² m/s for a thickness of 150 μm.

Coating is carried out on a copper current collector with a spread weight per unit area of 2 mg/cm², but it may also be carried out on a current collector made of nickel.

### Example 3

The negative electrode prepared in example 2 is then tested in a lithium metal battery (half-cell test) of the button battery type.

Each button battery is mounted in strict accordance with the same protocol.

The following are therefore stacked from the bottom of the battery base, as shown in FIG. 8:
a negative electrode according to the invention (16 mm diameter, 150 μm thickness) (1) deposited on a copper (or nickel) disk acting as a current collector;
150 μL of LPF₆ salt-based electrolyte liquid, at a concentration of 1 mol/L. in solution in a mixture of 1/1 by mass of ethylene carbonate and dimethyl carbonate, but any other non-aqueous liquid electrolyte known in the technique may be used;
the electrolyte is soaked into a separator which is a polyolefin microporous membrane, more precisely a microporous membrane made of Celgard polypropylene (2)Ø16.5 mm;
a positive electrode (3) made up of a disk of diameter 14 mm made of lithium metal;
a stainless steel disk or shim (4);
a stainless steel cover (5) and a stainless steel base (6);
a stainless steel spring (7) and a polypropylene seal (8);

The stainless steel case is then closed using a crimping device, rendering it fully air-tight.

In order to verify whether the batteries are operational, the latter are checked by measuring the floating voltage.

Due to the high reactivity of lithium and of its salts with oxygen and with water, assembly of the button battery is carried out in a glove box. This is kept at a slight excess pressure of an atmosphere of dry argon. Sensors are used to continuously monitor the oxygen and water concentrations. These concentrations must typically remain at the ppm level.

The button battery prepared in accordance with the procedure described above undergoes cycling, that is charging and discharging at different constant current regimes over a set number of cycles, in order to assess the practical capacity of the battery.

For example, a battery which charges under a C/20 regime battery to which a constant current is applied over 20 hours with the aim of recovering it entire capacity C. The current value is equal to the capacity C divided by the number of hours of charging, namely in this case 20 hours.

The capacity is 8.5 mAh. The forming at ambient temperature is carried out at C/20 for 5 hours and C/10 up to 4.2V. After this step a “float charge” is carried out at C/100 before a break of 5 minutes. The forming is ended by a pre-charge at C/5 up to 2.5V.

The cycling is at 20° C. at C/20 at 100% of the capacity.

### Example 4

In this example, a negative electrode is prepared as in example 2 with 80% of the material of the invention, 10% carbon black Super P, and 10% CMC with an electrode spread mass per unit area of 2 mg/cm³.

This electrode is then tested in a lithium metal battery (half-cell test) of the button battery type, following the same protocol as in example 3 for the assembly of the battery and for forming.

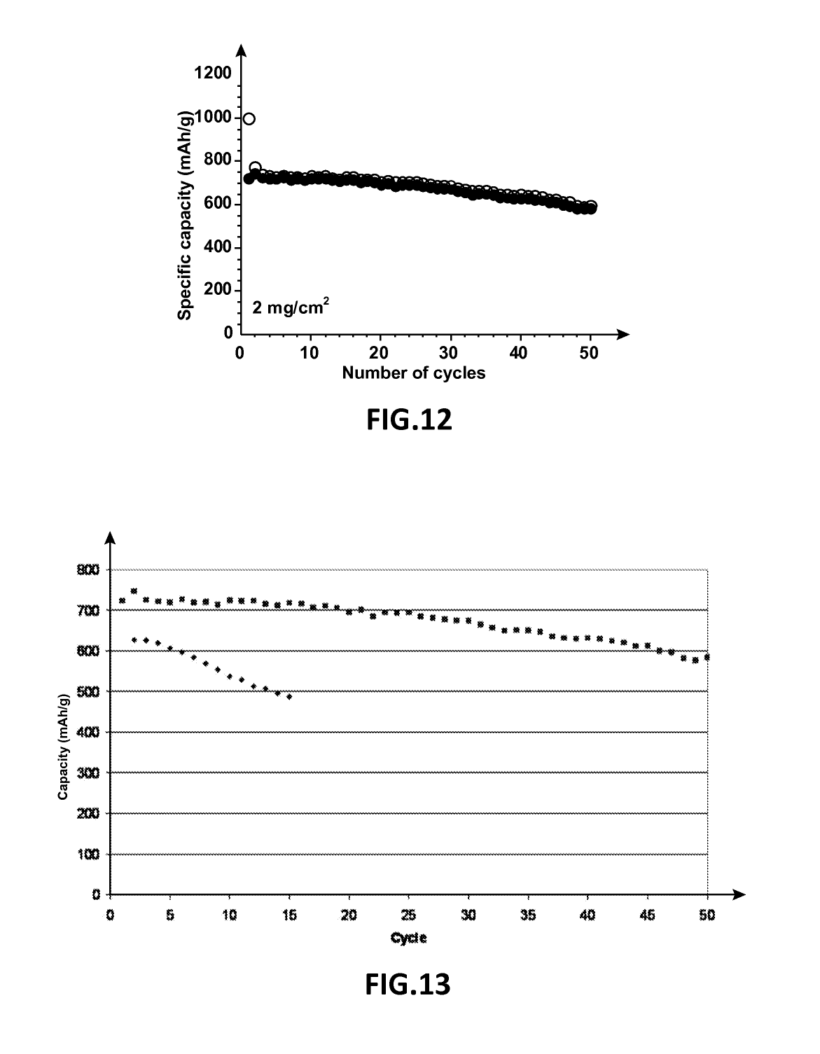

The performances of such a battery is represented in FIG. 12 and show charge capacities of greater than 600 mAh/g for capsules with improved cycling stability compared to the state of the art on silicon electrodes. The tests were carried out under C/20 cycles.

### Example 5

In this comparative example, a negative electrode is prepared according to the invention as in example 2 from an ink containing 80% of the material of the invention such as prepared in example 1, 10% carbon black and 10% CarboxyMethylCellulose with an electrode spread mass per unit area of 2 mg/cm³.

An electrode is in addition prepared which does not conform to the invention by a procedure which is analogous to that of example 2, from an ink which contains 80% of silicon powder, 10% of carbon black and 10% of CMC, with a spread mass per unit area of 2 mg/cm³.

Each of these electrodes is then tested in a lithium metal battery (half-cell test) of the button battery type assembled according to the protocol in example 3.

The tests were carried out at C/20 after prior forming at ambient temperature.

The results of these tests have been shown on FIG. 13.

The effect of the reinforced nanostructure of the silicon in the material according to the invention is shown in FIG. 13, where this material clearly improves the stability in cycling.

1. Silicon/carbon composite material, consisting of at least one capsule comprising a silicon shell within which there are carbon nano-objects partially or totally covered with silicon, and silicon nano-objects.

2. Material according to claim 1 wherein the capsule further comprises an amorphous carbon shell (carbon sub-shell inside the silicon shell and adjacent to the latter.

3. Material according to claim 2 wherein the silicon shell totally or partially covers the amorphous carbon sub-shell.

4. Material according to claim 1 wherein the carbon nano-objects are selected from nanotubes, nanowires, nanofibres, nanoparticles, carbon nanocrystals, carbon blacks, and mixtures thereof; and the silicon nano-objects are selected from nanotubes, nanowires, nanofibres, nanoparticles, silicon nanocrystals and mixtures thereof.

5. Material according to claim 4 wherein the carbon nano-objects are selected from carbon nanotubes and carbon nanofibres; and the silicon nano-objects are selected from silicon nanoparticles.

6. Material according to claim 1, wherein the porosity of the interior of the capsule is greater than 50%.

7. Material according to claim 1, wherein the silicon shell is a dense shell with a density of 1 to 3 g/cm³.

8. Material according to claim 1 wherein the carbon nano-objects form both a three-dimensional network which trap the silicon nano-objects and a three dimensional skeleton, partially or totally sheathed in silicon.

9. Material according to claim 1, wherein the capsule is in the form of a hollow sphere or quasi-sphere.

10. Material according to claim 1, wherein the capsule has a larger dimension of from 0.5 mm to 2.5 mm.

11. Material according to claim 1, wherein the silicon shell has a thickness of from 50 nm to 500 nm.

12. Material according to claim 1, wherein the silicon of the shell and the silicon which completely or partially covers the carbon nano-objects consists in majority, and optionally preferably totally, of amorphous silicon or partially or totally recrystallised cubic silicon.

13. Material according to claim 1, wherein the following are found inside the silicon shell:
a network of carbon nano-objects, partially or totally covered with amorphous silicon;
agglomerates of cubic silicon nano-objects which trap one or more carbon nano-object(s);
amorphous silicon seeds on the surfaces of the agglomerates;
amorphous silicon nanowires on the amorphous silicon seeds.

14. Material according to claim 13 wherein the carbon nano-objects which are partially or totally covered with amorphous silicon, and the silicon nanowires are partially or totally crystallised and twinned in the direction of the cross-section of the silicon nanowires and of the carbon nano-objects.

15. Method for preparing a silicon/carbon composite material according to claim 1, wherein:
freeze-dried capsules prepared by the freeze-drying of first capsules are placed inside a thermal chemical vapour deposition reactor under vacuum, said first capsules each comprising a solvent, carbon nano-objects and silicon nano-objects coated with macromolecules of a polysaccharide being distributed homogeneously in each of the first capsules, and said macromolecules forming, in at least part of each of the first capsules, a gel by cross-linking with positive ions;
a carrier gas is introduced into the reactor to form a fluidised bed of the freeze-dried capsules;
a silicon-containing silicon precursor compound is injected into the reactor, wherein a temperature and a pressure have been previously established such that silicon is deposited by evaporation and condensation on the carbon nano-objects inside the capsules, and such that the reaction
Si+SiO2→2 SiO is initiated and that evaporation and sorption of the SiO takes place at the surface of the silicon and of the carbon nano-objects;
the injection of the silicon-containing silicon precursor compound is stopped and a deoxygenation treatment of the capsules is carried out;
the reactor is cooled and the capsules are extracted from the reactor.

16. Method according to claim 15 wherein inside the freeze-dried capsules, the silicon nano-objects are distributed in a homogeneous manner inside a three-dimensional network of carbon nano-objects.

17. Method according to claim 15, wherein the freeze-dried capsules have a size defined by their largest dimension of from 2 mm to 3.5 mm.

18. Method according to claim 15, wherein the freeze-dried capsules consist as a mass percentage of from 50% to 70% of polysaccharide macromolecules, of from 20% to 40% of silicon, and of from 1% to 20% of carbon nanotubes.

19. Method according to claim 15, wherein the polysaccharide is selected from pectins, alginates, alginic acid, carrageenans and mixtures thereof.

20. Method according to claim 15, wherein the silicon-containing precursor is selected from silane, trichlorosilane and tetra alkyl silanes.

21. Method according to claim 15, wherein the carrier gas is selected from hydrogen, argon and mixtures thereof.

22. Method according to claim 15, wherein a temperature of from 900° C. to 1200° C. and a pressure of from 1 to 50 mbar is established in the reactor.

23. Method according to claim 15 wherein the deoxygenation treatment is carried out at a temperature of from 1000° C. to 1450° C. for a duration of from 5 minutes to 60 minutes in an atmosphere of pure hydrogen, or in an atmosphere of inert gas, or in an atmosphere of a mixture of hydrogen and of an inert gas.

24. Electrode comprising as an electrochemically active material the silicon/carbon composite material according to claim 1.

25. Electrode according to claim 24, which is a negative electrode.

26. Electrochemical system comprising an electrode according to claim 24.

27. Electrochemical system according to claim 26 which is a a rechargeable electrochemical battery with a non-aqueous electrolyte.

28. Electrochemical system according to claim 26 which is a lithium ion battery.
